(19) United States
(12) Patent Application Publication
(10) Pub. No.: US 2026/0015266 A1
(43) Pub. Date: Jan. 15, 2026

(54) WATER TREATMENT APPARATUS AND MANUFACTURING METHOD OF WATER TREATMENT APPARATUS

(71) Applicant: SAMSUNG ELECTRONICS CO., LTD., Suwon-si (KR)

(72) Inventors: Wonji JUNG, Suwon-si (KR); Jeeyeon Kim, Suwon-si (KR); Changhoon Oh, Suwon-si (KR); Sungpil Hong, Suwon-si (KR)

(73) Assignee: SAMSUNG ELECTRONICS CO., LTD., Suwon-si (KR)

(21) Appl. No.: 19/265,737

(22) Filed: Jul. 10, 2025

Related U.S. Application Data
(63) Continuation of application No. PCT/KR2025/007477, filed on May 30, 2025.

(30) Foreign Application Priority Data
Jul. 11, 2024 (KR) 10-2024-0092049

(51) Int. Cl. C02F 1/461; C02F 1/469

(52) U.S. Cl. CPC C02F 1/46109; C02F 1/4691

(57) ABSTRACT

A water treatment apparatus includes a first electrode including a first current collecting layer and a first porous electrode, a second electrode including a second current collecting layer and a second porous electrode, a deionization channel formed between the first electrode and the second electrode; and a flow changer provided as an internal structure within the deionization channel and configured to change a flow of fluid passing through the deionization channel. At least one of the first current collecting layer or the second current collecting layer may include a heating element configured to generate heat based on application of a voltage.

### CROSS-REFERENCE TO RELATED APPLICATIONS

This application is a bypass continuation application of International Patent Application No. PCT/KR2025/007477, filed on May 30, 2025, which claims priority from Korean Patent Application No. 10-2024-0092049, filed on Jul. 11, 2024, in the Korean Intellectual Property Office, the disclosure of which is incorporated herein by reference in its entirety.

### BACKGROUND

The present disclosure relates to a water treatment apparatus using a capacitive deionization (CDI) technology.

Deionization technology is widely used across various industries to remove hardness-causing components such as calcium and magnesium from water, particularly in areas having water with high hardness components. The treated water may be used as drinking water, boiler water, or cooling water in power plants or industrial facilities.

One example of deionization technology is capacitive deionization (CDI), which is used to remove ions by electrochemically adsorbing the ions onto electrodes with a high specific surface area.

A CDI apparatus may include a channel, electrodes with high specific surface areas at both sides of the channel to adsorb ions of a fluid flowing through the channel, and ion exchange membranes for selectively moving specific ions. The CDI apparatus may generate an electric field perpendicular to the fluid flow direction inside the channel to drive ion movement.

Such CDI apparatuses are included in home appliances such as dishwashers, washing machines, etc. The dishwashers or washing machines may require hot water to improve washing efficiency, and therefore, the dishwashers or washing machines may include hot water generators.

### SUMMARY

An aspect of the disclosure provides a water treatment apparatus capable of providing hot water and a method of manufacturing the water treatment apparatus.

An aspect of the disclosure provides a water treatment apparatus with improved efficiency and a method of manufacturing the water treatment apparatus.

The technical object intended to be achieved by the present document is not limited to the above-mentioned technical objects, and other technical objects not mentioned will be clearly understood by one of ordinary skill in the technical art to which the disclosure belongs from the following description.

According to an aspect of the present disclosure, a water treatment apparatus includes a first electrode including a first current collecting layer and a first porous electrode, a second electrode including a second current collecting layer and a second porous electrode, a deionization channel formed between the first electrode and the second electrode; and a flow changer provided as an internal structure within the deionization channel and configured to change a flow of fluid passing through the deionization channel. At least one of the first current collecting layer or the second current collecting layer includes a heating element configured to generate heat based on application of a voltage.

According to an aspect of the present disclosure, a water treatment apparatus includes: a first ion removing module including a first electrode, a second electrode, and a first deionization channel provided between the first electrode and the second electrode; and a second ion removing module including a third electrode, a fourth electrode, and a second deionization channel provided between the third electrode and the fourth electrode. At least one of the first electrode or the second electrode includes a heating element configured to generate heat based on application of a voltage. The third electrode and the fourth electrode include a material that is different from a material of the first electrode and the second electrode.

A method of manufacturing a water treatment apparatus according to a concept of the disclosure, the water treatment apparatus including a first electrode including a first current collector and a first porous electrode, a second electrode including a second current collector and a second porous electrode, and a deionization channel formed between the first electrode and the second electrode, may include operation of applying a carbon-based active material onto the second current collector or the first current collector including a heating element to form the first electrode or the second electrode. The heating element may include at least one metal selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

### DESCRIPTION OF DRAWINGS

FIG. 1 is a conceptual view of a water treatment apparatus according to one or more embodiments of the disclosure.

FIG. 2 shows an electrode for a water treatment apparatus, formed during an electrophoresis process according to one or more embodiments of the disclosure.

FIG. 3 shows a Scanning Electron Microscope (SEM) image of a part of an electrode for a water treatment apparatus, formed during an electrophoresis process according to one or more embodiments of the disclosure.

FIG. 4 shows a SEM image of a part of an electrode for a water treatment apparatus, formed during an electrophoresis process according to one or more embodiments of the disclosure.

FIG. 5 is a control block diagram of a water treatment apparatus according to one or more embodiments of the disclosure.

FIG. 6 is a conceptual view for describing movements of generated ions and changes in temperature of water while a water treatment apparatus according to one or more embodiments performs a deionization operation.

FIG. 7 is a conceptual view of a water treatment apparatus according to one or more embodiments of the disclosure.

FIG. 8 is a conceptual view of a water treatment apparatus according to one or more embodiments of the disclosure.

FIG. 9 is a conceptual view of a water treatment apparatus according to one or more embodiments of the disclosure.

FIG. 10 is a conceptual view of a water treatment apparatus according to one or more embodiments of the disclosure.

FIG. 11 is a conceptual view of a water treatment apparatus according to one or more embodiments of the disclosure.

FIG. 12 is a conceptual view of a water treatment apparatus according to one or more embodiments of the disclosure.

FIG. 13 is a conceptual view of a water treatment apparatus according to one or more embodiments of the disclosure.

FIG. 14 is a conceptual view of a water treatment apparatus according to one or more embodiments of the disclosure.

FIG. 15 shows a washing machine connected to a water treatment apparatus according to one or more embodiments of the disclosure.

FIG. 16 shows a cross section of a washing machine to which a water treatment apparatus according to one or more embodiments of the disclosure is applied.

FIG. 17 shows a refrigerator to which a water treatment apparatus according to one or more embodiments of the disclosure is connected.

FIG. 18 shows a refrigerator to which a water treatment apparatus according to one or more embodiments of the disclosure is connected, while a door of the refrigerator opens.

FIG. 19 shows a cross section of a refrigerator to which a water treatment apparatus according to one or more embodiments of the disclosure is applied.

FIG. 20 shows a dishwasher to which a water treatment apparatus according to one or more embodiments of the disclosure is connected.

FIG. 21 shows a cross section of a dishwasher to which a water treatment apparatus according to one or more embodiments of the disclosure is applied.

FIG. 22 shows a water purifier to which a water treatment apparatus according to one or more embodiments of the disclosure is applied.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1^{st}”, “2^{nd}”, or “first” or “second” may be used simply to distinguish a component from other components, without limiting the component in other aspects (e.g., importance or order).

A certain (e.g., first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A water treatment apparatus according to various embodiments may purify contaminated water to generate clean water. The water treatment apparatus may be used in sewage treatment equipment, industrial processes, and water supply systems within homes or offices to play a vital role in environment protection and human health. Water purified to a clean state by the water treatment apparatus may be released back into the nature, used for cleaning purposes, used as drinking water, or reused in industrial processes, etc.

According to various embodiments, the water treatment apparatus may include not only household devices such as a water purifier or a water softener, but also an industrial water treatment apparatus.

The water treatment apparatus may purify contaminated water through various methods, such as biological treatment methods, chemical treatment methods, and physical treatment methods.

The water treatment apparatus according to an embodiment may purify contaminated water through a capacitive deionization (CDI) method.

The capacitive deionization method removes ions from contaminated water by adsorbing/desorbing ions onto/from surfaces of electrodes by an electrical force generated between the electrodes. In the present specification, removing ions from contaminated water may include removing ionic materials from contaminated water.

The water treatment apparatus may include various components, such as a plurality of pipes through which water flows, a plurality of valves that controls a flow of water, and a capacitive deionization module that purifies water through a capacitive deionization method.

The capacitive deionization module may include a housing, containing a plurality of electrodes and a plurality of ion exchangers. Ions included in water flowed into the housing may be adsorbed onto or desorbed from the electrodes according to a voltage applied to the electrodes.

According to various embodiments, the water treatment apparatus may further include various components, such as a pre-treatment filter for pre-treating raw water and supplying the pre-treated water to the capacitive deionization module and/or a post-treatment filter for filtering water purified by the capacitive deionization module once again.

In the disclosure, a heating element may refer to a component including a material capable of generating heat when electric current is applied, and it may be implemented in various forms. The heating element may be a planar heating element such as a resistive film or sheet made from materials like carbon-based composites, metal foils (e.g., nickel-chromium alloys), or printed conductive inks, a wire heating element that may be formed from resistance wire wound into coils or laid out in patterns to distribute heat evenly, or a combined type of a planar heating element and a wire heating element.

Also, the “heating element” may be also referred to as “heating substance,” “heating material,” “heating source,” “heating metal,” or “heating alloy.” However, the heating element is not limited to the terms and may be replaced with any term indicating a material having a heating performance upon application of a voltage.

Also, in the disclosure, a porous electrode refers to a porous material layer formed on a current collector of an electrode for a water treatment apparatus, and the porous electrode may be replaced with terms, such as “active material layer,” “electrode active material layer,” “porous material layer,” “porous active material layer,” and “porous electrode active material layer.”

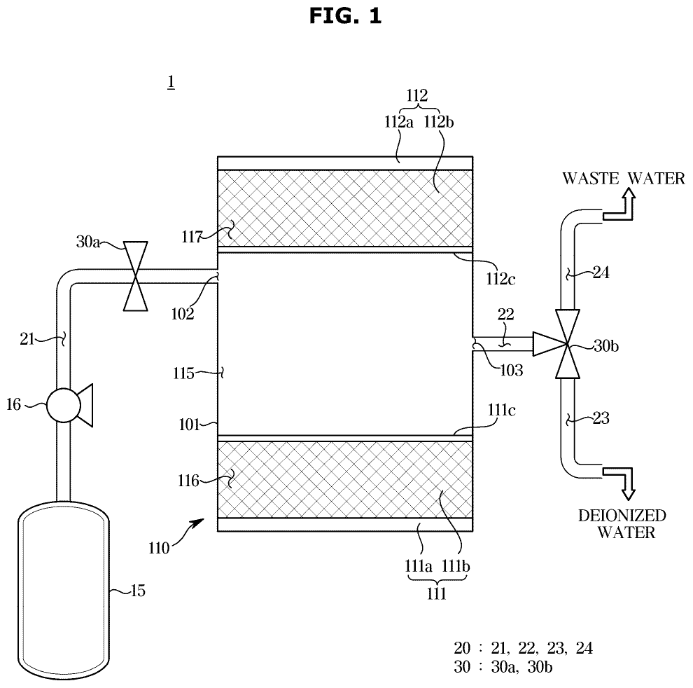

FIG. 1 is a conceptual view of a water treatment apparatus according to one or more embodiments of the disclosure.

Referring to FIG. 1, a water treatment apparatus 1 according to an embodiment may include an ion removing module 110.

The ion removing module 110 may include a first electrode 111 and a second electrode 112. The first electrode 111 and the second electrode 112 may face each other. The first electrode 111 and the second electrode 112 may form an electric field.

The first electrode 111 may include a first current collector 111a and a first porous electrode 111b. The first electrode 111 may be a positive electrode (anode) or a negative electrode (cathode). The first current collector 111a may be also referred to as a first current collecting layer or a first conductive layer, and examples of the first current collector 111a may include a graphite sheet, a carbon paper or cloth, a stainless steel plate, a titanium mesh or plate, a nickel foam, and a copper plate.

In an embodiment, the first current collector 111a may include a plate electrically connected to the first porous electrode 111b. The plate may include a metal plate and/or a non-metal plate.

The first current collector 111a may include a conductor. For example, the first current collector 111a may include graphite.

For example, the first current collector 111a may include a material that generates heat based on application of a voltage. For example, the first current collector 111a may include a material having high thermal resistance. The first current collector 111a may include a heating element having heating performance.

The heating element may include a metal having excellent conductivity and heating performance such that, when a voltage is applied to the water treatment apparatus 1, an electric field is uniformly distributed on the surfaces of electrodes.

The heating element is not particularly limited in kind as long as the heating element is a metal having heating performance, and the heating element may include at least metal selected from among, for example, nickel (Ni), chromium (Cr), molybdenum (Mo), tungsten (W), platinum (Pt), titanium (Ti), tantalum (Ta), nickel-chromium alloy (NiCr), iron-chromium alloy (FeCr), iron-nickel-chromium alloy (FeNiCr), iron-cobalt-nickel alloy (FcCoNi), iron-chromium-aluminum alloy (FeCrAl), tantalum-aluminum alloy (TaAl), stannous oxide (SnO), hafnium diboride (HfB2), ruthenium-chromium alloy (RuCr), iridium-chromium alloy (IrCr), or cobalt-chromium alloy (CoCr). For example, the heating element may include at least one metal selected from among Ni, Cr, or NiCr. The heating element may be used with a single component or may be used by combining several components.

The heating element may have electrical resistivity of 10⁻² Ωcm to 10⁻⁴ Ωcm at a room temperature. It may be difficult to form a heating element having excessively high resistivity that is higher than 10⁻² Ωcm, and such a heating element will fail to obtain desired heating performance due to low heating temperature. In contrast, a heating element having electrical resistivity that is lower than 10⁻⁴ Ωcm will generate excessive heat upon application of a voltage due to excessively low resistivity, resulting in incompatibility in terms of life and reliability.

The porous electrode 111b may include a solid electrode including an internal void space, enabling the diffusion and absorption of ions from the fluid. The first porous electrode 111b may include a material with a high affinity for ionic absorption. For example, the first porous electrode 111b may include a carbon porous electrode.

The first porous electrode 111b may include a thermally conductive material capable of transferring heat generated from the first current collector 111a to a deionization channel 115. The first porous electrode 111b may include a material capable of transferring heat generated from the heating element included in the first current collector 111a to the deionization channel 115. The first porous electrode 111b may include a material having a high heat transfer rate.

For example, the first porous electrode 111b may include a carbon-based active material including at least one selected from among activated carbon, graphene, carbon nanotubes, carbon fibers, or carbon aerogel. The carbon-based active material may be manufactured and applied in powder form.

The carbon-based active material may have an average particle size of 10 μm or less. For example, to increase a specific surface area and capacitance of the first porous electrode 111b, the carbon-based active material may have an average particle size of 10 nm to 10 μm.

For example, the first porous electrode 111b may have a thickness of 100 μm to 300 μm. For example, the first porous electrode 111b may have a thickness of 150 μm to 250 μm. For example, the first porous electrode 111b may have a thickness of 180 μm to 220 μm. In the case in which the thickness of the first porous electrode 111b is less than 100 μm or more than 300 μm, removal efficiency of divalent cations Ca2+ and Mg2+ included in raw water may be reduced. In consideration of this, the first porous electrode 111b may have a thickness of 100 μm to 300 μm to reduce electrical resistance and improve deionization efficiency.

For example, the first porous electrode 111b may be provided on a surface of the first current collector 111a including the heating element.

The second electrode 112 may include a second current collector 112a and a second porous electrode 112b. The second electrode 112 may be a positive electrode (anode) or a negative electrode (cathode). The second current collector 112a may be also referred to as a second current collecting layer or a second conductive layer, and examples of the second current collector 112a may include a graphite sheet, a carbon paper or cloth, a stainless steel plate, a titanium mesh or plate, a nickel foam, and a copper plate.

In an embodiment, the second current collector 112a may include a plate electrically connected to the second porous electrode 112b. The plate may include a metal plate and/or a non-metal plate.

The second current collector 112a may include a conductor. For example, the second current collector 112a may include the same configuration as the first current collector 111a. For example, the second current collector 112a may include graphite. In an embodiment, the second current collector 112a may include a material that is different from that of the first current collector 111a.

For example, the second current collector 112a may include a material that generates heat based on application of a voltage. The second current collector 112a may serve as an electrical conductor and a thermal energy source. For example, the second current collector 112a may include a material having high thermal resistance. The second current collector 112a may include a heating element having heating performance.

The heating element may include a metal having excellent conductivity and heating performance such that, when a voltage is applied to the water treatment apparatus 1, an electric field is uniformly distributed on the surfaces of electrodes.

The heating element is not particularly limited in kind as long as the heating element is a metal having heating performance, and may include at least one metal selected from among, for example, among Ni, Cr, Mo, W, Pt, Ti, Ta, NiCr, FeCr, FeNiCr, FeCoNi, FcCrAl, TaAl, SnO, HfB2, RuCr, IrCr, or CoCr. For example, the heating element may include at least one metal selected from among Ni, Cr, or NiCr. The heating element may be used with a single component or may be used by combining several components. The heating element may be implemented in various forms, such as thin-film traces, wire coils, or mesh structures.

The heating element may have electrical resistivity of 10⁻² Ωcm to 10⁻⁴ Ωcm at a room temperature. It may be difficult to form a heating element having excessively high resistivity that is higher than 10⁻² Ωcm, and such a heating element will fail to obtain desired heating performance due to low heating temperature. In contrast, a heating element having electrical resistivity that is lower than 10⁻⁴ Ωcm will generate excessive heat upon application of a voltage due to excessively low resistivity, resulting in incompatibility in terms of life and reliability.

According to various embodiments, the heating element of the second current collector 112a may include the same configuration as that of the first current collector 111a. However, the disclosure is not limited thereto, and the heating element of the second current collector 112a may include a configuration that is different from that of the first current collector 111a.

In the water treatment apparatus 1 according to various embodiments, the first current collector 111a may include a material that generates heat based on application of a voltage, the second current collector 112a may include a material that generates heat based on application of a voltage, and both the first current collector 111a and the second current collector 112a may include a material that generates heat based on application of a voltage.

In the water treatment apparatus 1 according to various embodiments, the first current collector 111a may include a heating element having heating performance based on application of a voltage, the second current collector 112a may include a heating element having heating performance based on application of a voltage, and both the first current collector 111a and the second current collector 112a may include a heating element having heating performance based on application of a voltage.

The second porous electrode 112b may include a solid electrode including an internal void space, enabling the diffusion and absorption of ions from the fluid. The second porous electrode 112b may include the same configuration as the first porous electrode 111b. The second porous electrode 112b may include a material with a high affinity for ionic absorption. For example, the second porous electrode 112b may include a carbon porous electrode. For example, the second porous electrode 112b may include a material that is different from that of the first porous electrode 111b.

The second porous electrode 112b may include a thermally conductive material capable of transferring heat generated from the second current collector 112a to the deionization channel 115. The second porous electrode 112b may include a material capable of transferring heat generated from the heating element included in the second current collector 112a to the deionization channel 115. The second porous electrode 112b may include a material having a high heat transfer rate.

For example, the second porous electrode 112b may include a carbon-based active material including at least one selected from among activated carbon, graphene, carbon nanotubes, carbon fibers, or carbon aerogel. The carbon-based active material may be manufactured and applied in powder form.

The carbon-based active material may have an average particle size of 10 μm or less. For example, to increase a specific surface area and capacitance of the second porous electrode 112b, the carbon-based active material may have an average particle size of 10 nm to 10 μm.

For example, the second porous electrode 112b may have a thickness of 100 μm to 300 μm. For example, the second porous electrode 112b may have a thickness of 150 μm to 250 μm. For example, the second porous electrode 112b may have a thickness of 180 μm to 220 μm. In the case in which the thickness of the second porous electrode 112b is less than 100 μm or more than 300 μm, removal efficiency of divalent cations Ca2+ and Mg2+ included in raw water may be reduced. In consideration of this, the second porous electrode 112b may have a thickness of 100 μm to 300 μm to reduce electrical resistance and improve deionization efficiency.

For example, the second porous electrode 112b may be provided on a surface of the second current collector 112a including the heating element.

The ion removing module 110 may include an anion exchange membrane 111c, which selectively allows the passage of anions while blocking cations. The anion exchange membrane 111c may include a membrane that transmits only anions among cations and anions. The anion exchange membrane 111c may have positive charges to transmit only anions while blocking transmission of cations by repulsion. For example, the anion exchange membrane 111c may include a polymer matrix embedded with quaternary ammonium functional groups, which impart positive fixed charges to the membrane structure. The positive charges repel cations and attract anions to enable electro-selective transport.

The ion removing module 110 may include an anion channel 116 formed between the first current collector 111a and the anion exchange membrane 111c. The anion channel 116 may include a space between the first current collector 111a and the anion exchange membrane 111c. In the anion channel 116, the first porous electrode 111b may be positioned.

The ion removing module 110 may include a cation exchange membrane 112c, which selectively allows the passage of cations while blocking anions. The cation exchange membrane 112c may include a membrane that transmits only cations among cations and anions. The cation exchange membrane 112c may have negative charges to transmit only cations while blocking transmission of anions by repulsion.

The ion removing module 110 may include a cation channel 117 formed between the second current collector 112a and the cation exchange membrane 112c. The cation channel 117 may include a space between the second current collector 112a and the cation exchange membrane 112c. In the cation channel 117, the second porous electrode 112b may be positioned.

The anion exchange membrane 111c and the cation exchange membrane 112c may include ion-selective permeable membranes which allows fluid and target ions to pass while maintaining separation of ionic species. For example, the anion exchange membrane 111c and the cation exchange membrane 112c may include synthetic resin membranes.

The ion removing module 110 may include the deionization channel 115. The deionization channel 115 may be formed between the anion exchange membrane 111c and the cation exchange membrane 112c. The deionization channel 115 may include a space between the anion exchange membrane 111c and the cation exchange membrane 112c. The first electrode 111 may be arranged to one side of the deionization channel 115, and the second electrode 112 may be arranged to another side that is opposite to the one side of the deionization channel 115.

The anion channel 116, the cation channel 117, and the deionization channel 115 may be replaced by terms, such as compartments, spaces, rooms, or chambers, in that the anion channel 116, the cation channel 117, and the deionization channel 115 are partitioned from each other by the ion exchange membranes 111c and 112c.

The anion channel 116, the cation channel 117, and the deionization channel 115 may be fluidically interconnected, allowing fluid communication among them. For example, a fluid present in the deionization channel 115 may flow into the anion channel 116 and/or the cation channel 117, and conversely, fluid in the anion channel 116 and/or the cation channel 117 may flow into the deionization channel 115.

While a positive voltage is applied to the first current collector 111a, the first electrode 111 may become a positive electrode (anode), and while a negative voltage is applied to the second current collector 112a, the second electrode 112 may become a negative electrode (cathode). Accordingly, while a positive voltage is applied to the first current collector 111a and a negative voltage is applied to the second current collector 112a, cations in the deionization channel 115 may move into the caution channel 117, and anions in the deionization channel 115 may move into the anion channel 116.

The anions moved into the anion channel 116 while the positive voltage is applied to the first current collector 111a may be adsorbed onto the first porous electrode 111b, and the cations moved into the cation channel 116 while the negative voltage is applied to the second current collector 112a may be adsorbed onto the second porous electrode 112b.

While a positive voltage is applied to the first current collector 111a and a negative voltage is applied to the second current collector 112a, heat may be generated in the first current collector 111a and/or the second current collector 112a. The heat generated in the first current collector 111a may be transferred to the deionization channel 115 through the first porous electrode 111b. The heat generated in the second current collector 112a may be transferred to the deionization channel 115 through the second porous electrode 112b.

The heat transferred to the deionization channel 115 may be transferred to water passing through the deionization channel 115. The heat provided to the deionization channel 115 may heat water passing through the deionization channel 115.

Applying a positive voltage to the first current collector 111a and applying a negative voltage to the second current collector 112a may include making a potential of the first current collector 111a higher than a potential of the second current collector 112a.

Applying a positive voltage to the first current collector 111a may include applying a negative voltage to the second current collector 112a.

Applying a positive voltage to the first current collector 111a and a negative voltage to the second current collector 112a may include applying a positive voltage between the first current collector 111a and the second current collector 112a.

Applying a positive voltage between the first current collector 111a and the second current collector 112a may include making a potential of the first current collector 111a higher than a potential of the second current collector 112a.

While a negative voltage is applied to the first current collector 111a, the first electrode 111 may become a negative electrode (cathode), and while a positive voltage is applied to the second current collector 112a, the second electrode 112 may become a positive electrode (anode). Accordingly, while a negative voltage is applied to the first current collector 111a and a positive voltage is applied to the second current collector 112a, cations in the cation channel 117 may move into the deionization channel 115, and anions in the anion channel 116 may move into the deionization channel 115.

While a negative voltage is applied to the first current collector 111a, anions adsorbed on the first porous electrode 111b may be desorbed from the first porous electrode 111b, and, while a positive voltage is applied to the second current collector 112a, cations adsorbed on the second porous electrode 112b may be desorbed from the second porous electrode 112b.

Applying a negative voltage to the first current collector 111a and applying a positive voltage to the second current collector 112a may include making a potential of the first current collector 111a lower than a potential of the second current collector 112a.

A negative voltage may be applied to the first current collector 111a and a positive voltage may be applied to the second current collector 112a.

Applying a negative voltage to the first current collector 111a and applying a positive voltage to the second current collector 112a may include applying a negative voltage between the first current collector 111a and the second current collector 112a.

Applying a negative voltage between the first current collector 111a and the second current collector 112a may include making a potential of the first current collector 111a lower than a potential of the second current collector 112a.

The water treatment apparatus 1 according to an embodiment of the disclosure may efficiently remove divalent cations such as calcium (Ca2+) and magnesium (Mg2+) from raw water through the first electrode 111 and/or the second electrode 112 while a voltage is applied to the ion removing module 110, thereby softening the water. Simultaneously, the softened water may be warmed by heat generated from the heating element included in the first current collector 111a and/or the second current collector 112a. Heat generated from the heating element included in the first current collector 111a may be transferred to the deionization channel 115 through the carbon-based active material included in the first porous electrode 111b. Heat generated from the heating element included in the second current collector 112a may be transferred to the deionization channel 115 through the carbon-based active material included in the second porous electrode 112b. According to this configuration, the water treatment apparatus 1 according to an embodiment of the disclosure may soften and warm raw water without requiring a separate heating device, enhancing system compactness and energy efficiency.

In an embodiment, the ion removing module 110 may include a module inlet 102 for receiving a fluid and a module outlet 103 for discharging a fluid. A fluid flowed into the ion removing module 110 through the module inlet 102 may pass through the deionization channel 115. The fluid that has passed through the deionization channel 115 may be discharged to outside of the ion removing module 110 through the module outlet 103.

In various embodiments, the ion removing module 110 may be configured as an ion removing cell including the pair of electrodes 111 and 112 and the deionization channel 115 for removing ions from a fluid. In various embodiments, the ion removing module 110 may be configured as an ion removing stack including the pair of electrodes 111 and 112 and the deionization channel 115 for removing ions from a fluid.

The water treatment apparatus 1 according to an embodiment may include a housing 101 having the module inlet 102 through which water flows into the water treatment apparatus 1, and the module outlet 103 through which deionized water resulting from removing hardness components from the water or wastewater with hardness components dissolved in the water is discharged from the water treatment apparatus 1.

In an embodiment, at least some sides of the housing 101 may be the current collectors 111a and 112a. Also, at least some sides of the housing 101 may be pads for supporting the current collectors 111a and 112a.

In an embodiment, the housing 101 may include the module inlet 102 through which water flows into the deionization channel 115, and the module outlet 103 through which deionized water or wastewater in the deionization channel 115 is discharged.

Water from the outside of the ion removing module 110 may flow into the deionization channel 115 through the module inlet 102. Water in the deionization channel 115 may be discharged to the outside of the ion removing module 110 through the module outlet 103.

The water treatment apparatus 1 may include a water source 15 in which raw water is stored or to which raw water is supplied from the outside. The raw water may include water that needs to be treated by the water treatment apparatus 1.

The water treatment apparatus 1 may include a pump 16 that pumps external water (e.g., water supplied from the water source 15).

The water treatment apparatus 1 may include at least one flow path 20 and at least one opening/closing device 30. The at least one flow path 20 may be diverged by the at least one opening/closing device 30. For example, the opening/closing device 30 may include a valve.

Water pumped by the pump 16 may flow into the at least one flow path 20 of the water treatment apparatus 1.

In an embodiment, external water may be pumped by the pump 16 and flow into a first flow path 21. The first flow path 21 may be configured to receive external water.

The first flow path 21 may be connected to the module inlet 102.

A first opening/closing device 30a may open or close the first flow path 21. The first opening/closing device 30a may block or allow a flow of water from the first flow path 21 to the deionization channel 115. The first opening/closing device 30a may be a valve, such as a solenoid valve, a motorized valve, a pinch valve, or a gate valve.

Water that has flowed into the deionization channel 115 through the first flow path 21 may be discharged to the second flow path 22. The second flow path 22 may be connected to the module outlet 103.

A second opening/closing device 30b may allow water flowing through the second flow path 22 to flow into any one of a third flow path 23 or a fourth flow path 24. That is, the second opening/closing device 30b may allow water discharged from the deionization channel 115 to flow into any of the third flow path 23 or the fourth flow path 24. In an embodiment, the second opening/closing device 30b may close the second flow path 22 to block water flowing through the second flow path 22 from flowing into the third flow path 23 or the fourth flow path 24. The second opening/closing device 30b may be a valve, such as a solenoid valve, a motorized valve, a pinch valve, or a gate valve.

The third flow path 23 may include a flow path through which purified water (or deionized water) is discharged. The fourth flow path 34 may include a flow path through which contaminated water (or wastewater) is discharged.

According to various embodiments, the number of the module inlet 102, the number of the module outlet 103, a kind of the flow path 20, and/or a kind of the opening/closing device 30 are not limited to an example shown in FIG. 1.

Hereinafter, a method of manufacturing the water treatment apparatus 1 according to an embodiment of the disclosure will be described in detail.

The method of manufacturing the water treatment apparatus 1 according to an embodiment of the disclosure, the water treatment apparatus 1 including the first electrode 111 including the first current collector 111a and the first porous electrode 111b, the second electrode 112 including the second current collector 112a and the second porous electrode 112b, and the deionization channel 115 formed between the first electrode 111 and the second electrode 112, may include operation of applying a carbon-based active material onto at least one of both sides of the second current collector 112a or the first current collector 111a including the heating element to form the first electrode 111 or the second electrode 112.

The heating element of the first current collector 111a and/or the second current collector 112a may include at least one metal selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr, as described above. For example, the heating element of the first current collector 111a and/or the second current collector 112a may include at least one metal selected from among Ni, Cr, or NiCr. The heating element of the first current collector 111a and/or the second current collector 112a may have electrical resistivity of 10⁻² Ωcm to 10⁻⁴ Ωcm at a room temperature.

The porous electrodes 111b and 112b may be formed on the current collectors 111a and 112a, for example, by using methods such as spraying, dip coating, knife casting, doctor blade, and spin coating. In this case, the porous electrodes 111b and 112b may be respectively formed with a thickness of 100 μm to 300 μm on the current collectors 111a and 112a to improve deionization efficiency while reducing electrical resistance.

The carbon-based active material may include at least one selected from among activated carbon, graphene, carbon nanotubes, carbon fibers, or carbon aerogel. For example, by repeatedly applying the carbon-based active material one or more times, a desired thickness may be achieved.

Also, the porous electrodes 111b and 112b may be formed in such a way to form a porous electrode in a heating element by applying a voltage to a solution containing the heating element and a carbon-based active material.

For example, by applying a voltage to a solution containing a heating element, a carbon-based active material, and a solvent to perform electrophoretic deposition (EPD), a heating element metal may be eluted in a cation state by a side effect during the EPD process, and the metal eluted in the cation state and the carbon-based active material included in the solution may form cross-links to form a porous electrode on a surface of the heating element.

In this case, the carbon-based active material may include at least one selected from among activated carbon, graphene, carbon nanotubes, carbon fibers, or carbon aerogel, and the carbon-based active material may include a hydroxyl group, a carboxyl group, or the like to have negative charges for bonding with the heating element metal eluted in the cation state.

The water treatment apparatus 1 according to an embodiment of the present disclosure as described above may soften raw water by efficiently removing divalent cations contained in the water through the first porous electrode 111b or the second porous electrode 112b, while warming the softened water by the heating element contained in the first current collector 111a or the second current collector 112a, thereby enabling supply of hot water to a home appliance to which the water treatment apparatus 1 is applied and enhancing a cleaning and washing effect.

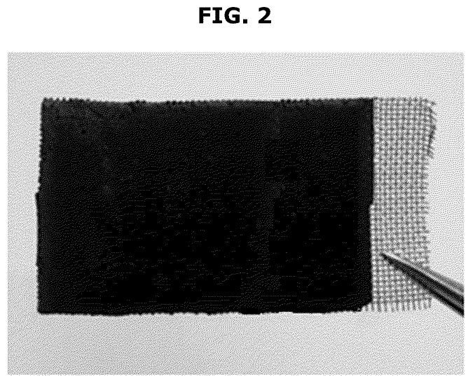

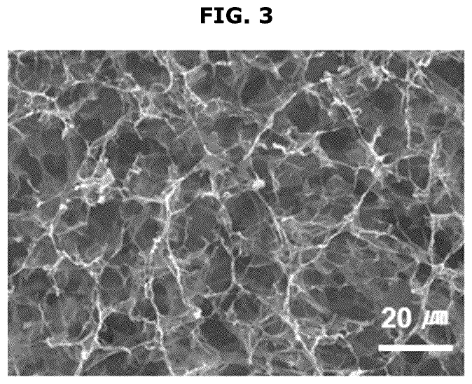

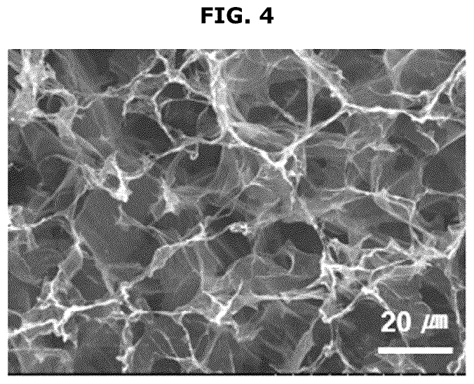

FIG. 2 shows an electrode for a water treatment apparatus, formed during an electrophoresis process according to one or more embodiments of the disclosure. FIG. 3 shows a Scanning Electron Microscope (SEM) image of a part of an electrode for a water treatment apparatus, formed during an electrophoresis process according to one or more embodiments of the disclosure. FIG. 4 shows a SEM image of a part of an electrode for a water treatment apparatus, formed during an electrophoresis process according to one or more embodiments of the disclosure.

For example, an electrode for a water treatment apparatus according to an embodiment of the disclosure may be manufactured as follows. The following embodiment may be only an example of the disclosure, and a scope of the disclosure is not limited thereto.

In an embodiment, the electrode for the water treatment apparatus according to the disclosure may be prepared as an electrode slurry by dissolving polyvinylidene fluoride in dimethylacetamide, then adding graphene oxide, and stirring the result. By casting the electrode slurry on a NiCr alloy as a current collector using a doctor blade and then drying the result in a drying oven, an electrode having a thickness of 100 μm to 300 μm may be formed.

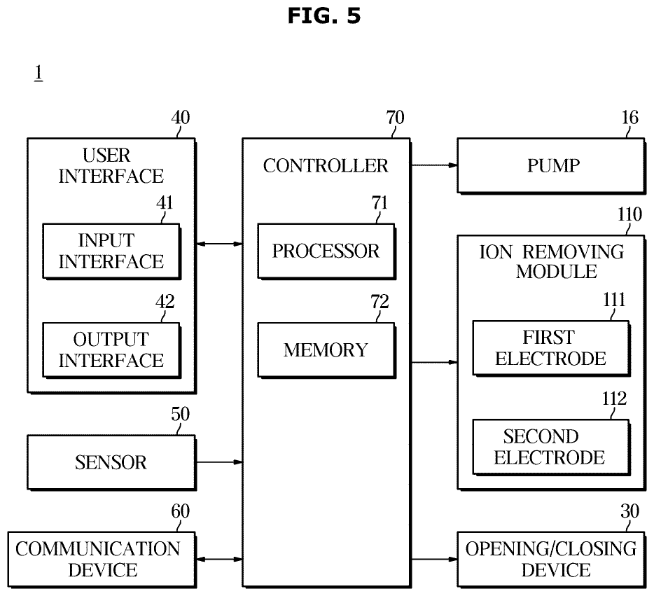

In another embodiment, the electrode for the water treatment apparatus according to the disclosure may be formed by an electrophoretic deposition process of dissolving graphene oxide in dimethylacetamide, adding a NiCr alloy mesh to the solution, and applying a voltage. At this time, pH of the solution may be 7, and the voltage is controlled to −0.5 V to −2 V to induce dissolution of Ni+ ions from the NiCr alloy mesh, thereby manufacturing the electrode for the water treatment apparatus in which graphene oxide is combined on a surface of the NiCr alloy mesh (see FIG. 2). Images of the electrode photographed by a SEM are shown in FIGS. 3 and 4, and it may be confirmed from FIGS. 3 and 4 that the electrode for the water treatment apparatus according to another embodiment of the disclosure is an electrode having a porous structure on a NiCr surface. The electrode shown in FIGS. 3 and 4 may correspond to a first electrode 111 and/or a second electrode 112 in FIG. 5.

FIG. 5 is a control block diagram of a water treatment apparatus according to one or more embodiments of the disclosure.

Referring to FIG. 5, the water treatment apparatus 1 according to an embodiment may include a user interface 40, a sensor 50, a communication device 60, the pump 16, the at least one opening/closing device 30, the ion removing module 110, and/or a controller 70.

The user interface 40 may include at least one input interface 41 and at least one output interface 42.

The at least one input interface 41 may convert sensory information received from a user into an electrical signal.

The at least one input interface 41 may include a power input interface for powering on the water treatment apparatus 1, an operation input interface for starting the water treatment apparatus 1, an operation mode selection input interface, and a setting input interface. The at least one input interface 41 may include, for example, a tact switch, a push switch, a slide switch, a toggle switch, a micro switch, a touch switch, a touch pad, a touch screen, a jog dial, and/or a microphone.

The water treatment apparatus 1 may perform a deionization process on water provided to the ion removing module 110 in a deionization operation.

The operation mode selection input interface may include an interface for enabling an operator to select an operation mode that will first start according to operation initiation of the water treatment apparatus 1 by the operation input interface.

The operator of the water treatment apparatus 1 may select an operation mode that will first start from among operation modes of the water treatment apparatus 1, through the operation mode selection input interface.

The setting input interface may include an interface for enabling the operator to set setting values for various components (e.g., the pump 16 and the electrodes 111 and 112) of the water treatment apparatus 1.

For example, the setting input interface may enable an operator to adjust settings, such as revolutions per minutes (RPM) of the pump 16 to control a flow rate of water supplied to the ion removing module 110, or a voltage level applied to the electrodes 111 and 112 to regulate ion removal efficiency.

The at least one output interface 42 may generate sensory information and transfer various information related to operations of the water treatment apparatus 1 to a user.

For example, the at least one output interface 42 may transfer an operation time of the water treatment apparatus 1, information related to settings of the water treatment apparatus 1, and information obtained from the sensor 50 to a user. Information of the water treatment apparatus 1 may be output in the form of a screen, an indicator, a voice, etc. The at least one output interface 42 may include, for example, a Liquid Crystal Display (LCD) panel, a Light Emitting Diode (LED) panel, a speaker, etc.

The sensor 50 may include at least one sensor for obtaining information related to an operation state of the water treatment apparatus 1.

For example, the sensor 50 may include a water quality sensor for detecting water quality of water discharged through the module outlet 103.

The water quality sensor may include various sensors, such as, for example, a turbidity sensor, a Total Dissolved Solids (TDS) sensor, a pH sensor, an electrical conductivity sensor, a hardness sensor, a flow sensor, and the like.

The water quality sensor may be positioned on the second flow path 22, the third flow path 23, and/or the fourth flow path 24 to detect water quality of water discharged through the module outlet 103. However, the water quality sensor may be positioned at any location for sensing water quality of water discharged from the ion removal module 110.

Information obtained by the sensor 50 may be transferred to the controller 70.

Information obtained by the sensor 50 may be output through the output interface 42.

The water treatment apparatus 1 may include the communication device 60 for communicating with an external device (e.g., a server, a user equipment, and/or a home appliance) by wire and/or wirelessly.

The communication device 60 may include at least one of a short-range communication module or a long-distance communication module.

The communication device 60 may transmit data to the external device or receive data from the external device. For example, the communication device 60 may establish communication with a server, a user equipment, and/or a home appliance and transmit/receive various data to/from the server, the user equipment, and/or the home appliance.

To this end, the communication device 60 may establish a direct (e.g., wired) communication channel or a wireless communication channel with the external device and support communication through the established communication channel. According to an embodiment, the communication device 60 may include a wireless communication module (e.g., a cellular communication module, a short-range communication module, or a global navigation satellite system (GNSS) communication module) or a wired communication module (e.g., a local area network (LAN) communication module or a power line communication module). A corresponding communication module among the communication modules may communicate with the external device through a first network (e.g., a short-range communication network, such as Bluetooth, WiFi Direct, or Infrared data association (IrDA)) or a second network (e.g., a long-range communication network, such as a legacy cellular network, a 5G network, a next-generation communication network, the Internet, or a computer network (e.g., a LAN or a wide area network (WAN)). The various kinds of communication modules may be integrated into a single component (e.g., a single chip) or implemented with a plurality of components (e.g., a plurality of chips).

The short-range wireless communication module may include, but is not limited thereto, a Bluetooth communication module, a Bluetooth Low Energy (BLE) communication module, a Near Field Communication (NFC) communication module, a Wireless Local Area Network (WLAN; WiFi) communication module, a Zigbee communication module, an IrDA communication module, a Wi-Fi Direct (WFD) communication module, a Ultrawideband (UWB) communication module, an Ant+ communication module, a microwave (uWave) communication module, etc.

The long-distance wireless communication module may include a communication module that performs various kinds of long-distance communications, and may include a mobile communication device 60. The mobile communication device 60 may transmit/receive a wireless signal to/from at least one of a base station, an external terminal, or a server on a mobile communication network.

In an embodiment, the communication device 60 may communicate with an external device, such as a server, a user equipment, a home appliance, etc., through a surrounding Access Point (AP). The AP may connect a LAN to which the water treatment apparatus 1, a home appliance, and/or a user equipment is connected to a WAN to which a server is connected. The water treatment apparatus 1, the home appliance, and/or the user equipment may be connected to the server through the WAN.

The communication device 60 may receive information about water quality of water discharged through the module outlet 103 from an external device.

For example, in the case in which a sensor for detecting water quality of water discharged through the module outlet 103 is installed outside the water treatment apparatus 1, the communication device 60 may receive information about water quality of water discharged through the module outlet 103 from the sensor installed outside the water treatment apparatus 1.

Information obtained by the communication device 60 may be transferred to the controller 70.

The communication device 60 may transfer information about water quality of water obtained from the sensor 50 to an external device (e.g., a server, a user equipment, or a home appliance).

The controller 70 may control various components (e.g., the user interface 40, the sensor 50, the communication device 60, the pump 16, the ion removing module 110, and/or the at least one opening/closing device 30) of the water treatment apparatus 1. For example, the controller 70 may control a voltage that is applied to the first electrode 111 and the second electrode 112.

The controller 70 may include hardware, such as a central processing unit (CPU), Micom, or a memory, and software such as a control program. For example, the controller 70 may include at least one memory 72 that stores data in the form of an algorithm or program for controlling operations of the components in the water treatment apparatus 1, and at least one processor 71 which performs the above-described operations and operations which will be described below by using the data stored in the at least one memory 72. The memory 72 and the processor 71 may be implemented with separate chips. The processor 71 may include one, two, or more processor chips or one, two, or more processing cores. The memory 72 may include one, two, or more memory chips or one, two, or more memory blocks. Also, the memory 72 and the processor 71 may be implemented with a single chip.

The controller 70 may be electrically connected to the user interface 40, the sensor 50, the communication device 60, the pump 16, the ion removing module 110, and/or the at least one opening/closing device 30.

The pump 16 may pump external water to the first flow path 21 according to a control signal from the controller 70.

The at least one opening/closing device 30 may change a flow of water to the at least one flow path 20 according to a control signal from the controller 70. The at least one valve 30 may include the first opening/closing device 30a and/or the second opening/closing device 30b.

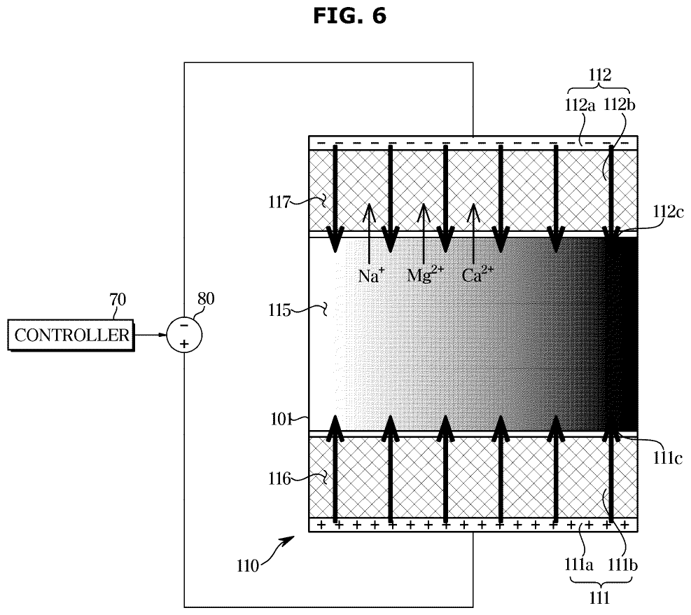

FIG. 6 is a conceptual view for describing movements of generated ions and changes in temperature of water while a water treatment apparatus according to one or more embodiments performs a deionization operation.

Referring to FIG. 6, the controller 70 may control a power supply 80 to apply a negative voltage to the second current collector 112a and to apply a positive voltage to the first current collector 111a in a deionization operation. The power supply 80 may be a bipolar power supply configured to output dual-polarity outputs, or a programmable power supply that is controllable by a software program executed by the controller 70. The controller 70 may include, in addition to the processor 71 and the memory 72 as shown in FIG. 5, a microcontroller (MCU) configured to output control signals such as logic high/low signals or pulse-width modulation (PWM) signals, based on input from the processor 71. The controller 70 may also include logic controllers such as logic gates or flip-flops, a field-programmable gate array (FPGA)-based controller, or a complex programmable logic device (CPLD)-based controller.

According to the applying of the negative voltage to the second current collector 112a, cations contained in water in the deionization channel 115 may move to the cation channel 117.

The cations included in the water may include, for example, sodium ions (Na+), magnesium ions (Mg2+), calcium ions (Ca2+), etc.

The cations contained in the water in the deionization channel 115 may move to the cation channel 117 and be adsorbed onto the second porous electrode 112b.

Accordingly, while the water treatment apparatus 1 performs a deionization operation, cations contained in water in the deionization channel 115 may be removed.

A negative voltage may be applied to the second current collector 112a and a positive voltage may be applied to the first current collector 111a.

While a positive voltage is applied to the first current collector 111a, anions contained in the water in the deionization channel 115 may move to the anion channel 116.

While a positive voltage is applied to the first current collector 111a and a negative voltage is applied to the second current collector 112a, heat may be generated in the first current collector 111a and/or the second current collector 112a. Heat generated in the first current collector 111a may be transferred to the deionization channel 115 through the first porous electrode 111b. Heat generated in the second current collector 112a may be transferred to the deionization channel 115 through the second porous electrode 112b. Water passing through the deionization channel 115 may be heated by the heat transferred to the deionization channel 115.

Based on applying of a positive voltage to the first current collector 111a and applying of a negative voltage to the second current collector 112a, the ion removing module 110 of the water treatment apparatus 1 may remove ions from water passing through the deionization channel 115 while heating the water passing through the deionization channel 115.

According to this configuration, the water treatment apparatus 1 according to an embodiment of the disclosure may remove cations included in water while heating the water without a separate heating device.

In addition, the water treatment apparatus 1 according to an embodiment of the disclosure may heat water passing through the deionization channel 115, and, while the water is heated, ion mobility may increase accordingly, which improves ion removal efficiency.

In the water treatment apparatus 1 according to an embodiment of the disclosure, while a voltage is applied, the heating element of the first current collector 111a and/or the second current collector 112a may generate heat due to a heating property, and the generated heat may be transferred to water flowed into the ion removing module 110 of the water treatment apparatus 1, which increases temperature of the water. That is, because the heating element of the first current collector 111a and/or the second current collector 112a has heating capability and thermal conductivity according to applying of a voltage to the ion removing module 110 of the water treatment apparatus 1, the water treatment apparatus 1 may change low-temperature hard water to high-temperature soft water without requiring a separate heating device for warming water.

Because a magnitude of the positive voltage applied to the first collector 111a in the deionization operation is set in advance within a range in which water in the anion channel 116 is not electrolyzed, electrolysis of water does not occur at the first electrode 111 which is the anode.

The absence of water electrolysis may indicate that a reaction rate of a water electrolysis reaction is significantly slow such that electrolysis of water hardly occurs.

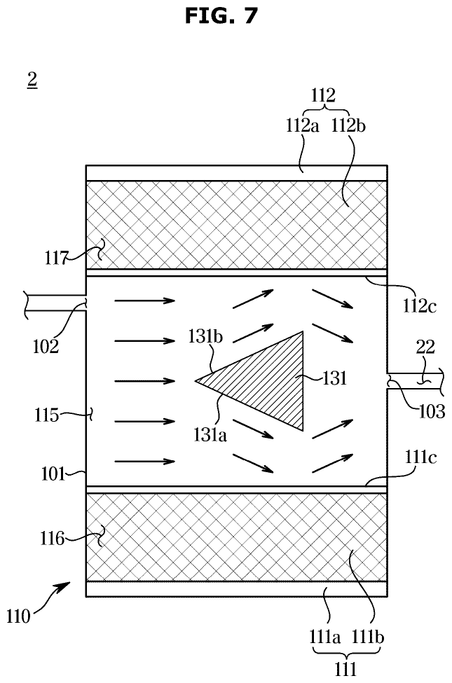

FIG. 7 is a conceptual view of a water treatment apparatus according to one or more embodiments of the disclosure.

A water treatment apparatus 2 according to an embodiment of the disclosure will be described with reference to FIG. 7. The same components as those of the water treatment apparatus 1 shown in FIG. 2 are assigned like reference numerals, and detailed descriptions thereof may be omitted.

The water treatment apparatus 2 according to an embodiment of the disclosure may include the ion removing module 110. As fluid flows through the deionization channel 115 of the ion removing module 110, its flow rate may vary depending on its position relative to the first electrode 111 and the second electrode 112. Specifically, the fluid may have a relatively fast flow rate in regions farther away from the first electrode 111 and the second electrode 112, and a relatively slow flow rate in regions closer to the first electrode 111 and the second electrode 112. In addition, relatively less heat energy may be transferred in a center area of the deionization channel 115 that is father from the first electrode 111 and the second electrode 112, compared to a side area of the deionization channel 115 that is closer to the first electrode 111 or the second electrode 112. Accordingly, fluid flowing near the first electrode 111 or the second electrode 112 may be relatively quickly heated, while fluid flowing through the center area may heat relatively slowly. Therefore, a temperature of fluid near the first electrode 111 or the second electrode 112 may be higher than a temperature of fluid farther away from the first electrode 111 and the second electrode 112.

Also, because a fluid passing through the side area of the deionization channel 115 that is close to the first electrode 111 or the second electrode 112 is heated by the first electrode 111 or the second electrode 112, the fluid may have a small temperature difference from the first electrode 111 and the second electrode 112, and accordingly, heat transfer from the first electrode 111 and the second electrode 112 to the deionization channel 115 may be reduced.

Referring to FIG. 7, the water treatment apparatus 2 according to an embodiment of the disclosure may include a flow changer 131. The flow changer 131 may be an internal structure placed within the deionization channel 115 to disrupt lamina flow, promote mixing, and equalize temperature gradient across the fluid stream by redistributing hotter and cooler fluid regions. The flow changer 131 may be a static structure fixed at a specific location within the deionization channel 115, or may be a mobile structure capable of floating and moving with the fluid within the deionization channel 115. The flow changer 131 may reduce a temperature difference between a temperature of a fluid passing through the area close to the first electrode 111 or the second electrode 112 and a temperature of a fluid passing through the area spaced from the first electrode 111 and the second electrode 112. The flow changer 131 may reduce a temperature difference between a temperature of a fluid passing through the side area of the deionization channel 115 and a temperature of a fluid passing through the center area of the deionization channel 115.

The flow changer 131 according to an embodiment of the disclosure may mix a fluid flowing through the center area of the deionization channel 115 with a fluid flowing through a side area of the deionization channel 115 close to the first electrode 111 or a fluid flowing through another side area of the deionization channel 115 close to the second electrode 112. The flow changer 131 may guide the fluid flowing through the center area of the deionization channel 115 to the side area of the deionization channel 115 close to the first electrode 111 or the side area of the deionization channel 115 close to the second electrode 112.

The flow changer 131 may change a linear flow of a fluid passing through the deionization channel 115 into a turbulent flow. The flow changer 131 may generate turbulence inside the deionization channel 115 while the fluid passes through the deionization channel 115.

For example, the flow changer 131 may be positioned inside the deionization channel 115. The flow changer 131 may be positioned in the center area of the deionization channel 115. The flow changer 131 may be positioned between the first electrode 111 and the second electrode 112. A spacing distance between the flow changer 131 and the first electrode 111 may be equal to a spacing distance between the flow changer 131 and the second electrode 112.

For example, the flow changer 131 may include a first guide surface 131a that extends closer to the first electrode 111 in a direction in which a fluid passing through the deionization channel 115 flows, and a second guide surface 131b that extends closer to the second electrode 112 in the direction in which a fluid passing through the deionization channel 115 flows. The first guide surface 131a may guide a fluid flowing through the center area of the deionization channel 115 to the side area that is close to the first electrode 111. The second guide surface 131b may guide a fluid flowing through the center area of the deionization channel 115 to the side area that is close to the second electrode 112. For example, a cross section of the flow changer 131 that is parallel to the direction in which a fluid flows through the deionization channel 115 may be a triangle.

For example, the flow changer 131 may include a heat resistant material. The flow changer 131 may include a material capable of withstanding a temperature of water that passes through the deionization channel 115 and is heated. For example, the flow changer 31 may include a material that does not dissolve in water.

In the water treatment apparatus 2 according to an embodiment of the disclosure, because, while fluids pass through the deionization channel 115, a temperature of a fluid passing through the center area becomes lower than a temperature of a fluid passing through the side area that is close to the first electrode 111 or the second electrode 112, the flow changer 131 may guide the fluids such that the fluid passing through the center area of the deionization channel 115 is mixed with the fluid passing through the side area, thereby reducing a temperature difference between the fluids passing through the deionization channel 115.

Meanwhile, a fluid passing through the deionization channel 115 of the ion removing module 110 may have a relatively fast flow rate as the fluid is located farther away from the cation exchange membrane 112c and the anion exchange membrane 111c, and a relatively slow flow rate as the fluid is located closer to the cation exchange membrane 112c and the anion exchange membrane 111c. Accordingly, among fluids passing through the deionization channel 115, ions of a fluid passing through an area that is close to the cation exchange membrane 112c or the anion exchange membrane 111c may be relatively rapidly removed, and ions of a fluid passing through an area that is spaced from the cation exchange membrane 112c or the anion exchange membrane 111c may be relatively slowly removed. Therefore, among fluids passing through the deionization channel 115, an ion concentration of a fluid passing through the area that is close to the cation exchange membrane 112c or the anion exchange membrane 111c may be lower than an ion concentration of a fluid passing through the area that is spaced from the cation exchange membrane 112c and the anion exchange membrane 111c.

Because the water treatment apparatus 2 according to an embodiment of the disclosure includes the flow changer 131 provided in the deionization channel 115, the water treatment apparatus 2 may reduce a difference between an ion concentration of a fluid passing through the area that is close to the cation exchange membrane 112c or the anion exchange membrane 111c and an ion concentration of a fluid passing through the area that is spaced from the cation exchange membrane 112c or the anion exchange membrane 111c. The flow changer 131 may reduce an ion concentration difference between fluids passing through the deionization channel 115 by mixing a fluid flowing through the center area of the deionization channel 115 with a fluid passing through the side area of the deionization channel 115 that is close to the first electrode 111 or a fluid passing through the side area of the deionization channel 115 that is close to the second electrode 112.

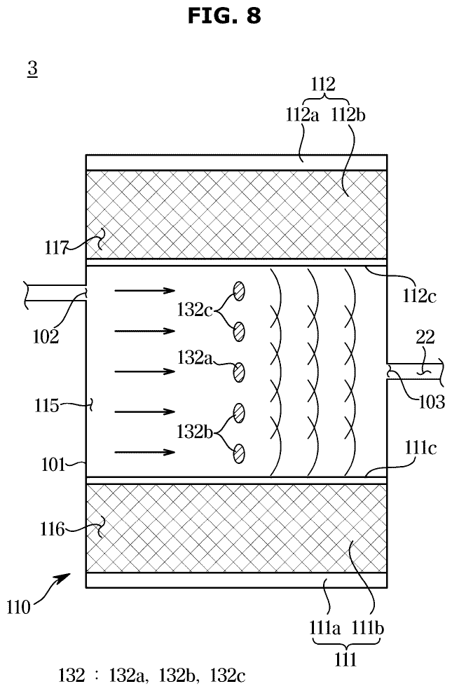

FIG. 8 is a conceptual view of a water treatment apparatus according to one or more embodiments of the disclosure.

A water treatment apparatus 3 according to an embodiment of the disclosure will be described with reference to FIG. 8. The same components as those of the water treatment apparatus 1 shown in FIG. 1 are assigned like reference numerals, and detailed descriptions thereof may be omitted.

Referring to FIG. 8, the water treatment apparatus 3 according to an embodiment of the disclosure may include a flow changer 132. The flow changer 132 may reduce a temperature difference between a temperature of a fluid passing through the area that is close to the first electrode 111 or the second electrode 112 and a temperature of a fluid passing through the area that is spaced from the first electrode 111 and the second electrode 112. The flow changer 132 may reduce a difference between a temperature of a fluid passing through the side area of the deionization channel 115 and a temperature of a fluid passing through the center area of the deionization channel 115.

The flow changer 132 according to an embodiment of the disclosure may mix a fluid passing through the center area of the deionization channel 115 with a fluid passing through the side area of the deionization channel 115 that is close to the first electrode 111 or a fluid flowing through the side area of the deionization channel 115 that is close to the second electrode 112. The flow changer 132 may guide a fluid flowing through the center area of the deionization channel 115 to the side area of the deionization channel 115 that is close to the first electrode 111 or the side area of the deionization channel 115 that is close to the second electrode 112.

The flow changer 132 may change a linear flow of a fluid passing through the deionization channel 115 to a turbulent flow. The flow changer 132 may generate turbulence inside the deionization channel 115 while a fluid passes through the deionization channel 115.

The flow changer 132 according to an embodiment of the disclosure may be positioned inside the deionization channel 115. The flow changer 132 may include a first change part 132a located at the center area of the deionization channel 115. For example, the first change part 132a may be located at a center area between the first electrode 111 and the second electrode 112. A spacing distance of the first change part 132a to the first electrode 111 may be equal to a spacing distance of the first change part 132a to the second electrode 112. For example, a cross section of the first change part 132 that is parallel to the direction in which a fluid flows through the deionization channel 115 may be a circle or ellipse.

For example, the first change part 132a may include a heat resistant material. The first change part 132a may include a material capable of withstanding a temperature of water that passes through the deionization channel 115 and is heated. For example, the first change part 132a may include a material that does not dissolve in water.

The flow changer 132 according to an embodiment of the disclosure may include a second change part 132b positioned between the first change part 132a and the first electrode 111 inside the deionization channel 115. For example, the second change part 132b may have the same configuration as the first change part 132a. For example, the second change part 132b may include a plurality of parts.

The flow changer 132 according to an embodiment of the disclosure may include a third change part 132c positioned between the first change part 132a and the second electrode 112 inside the deionization channel 115. For example, the third change part 132c may have the same configuration as the first change part 132a. For example, the third change part 132c may include a plurality of parts.

For example, the first change part 132a, the second change part 132b, and the third change part 132c may be arranged in a direction from the first electrode 111 toward the second electrode 112. The first change part 132c may be spaced from the second change part 132b and/or the third change part 132c. A fluid passing through the deionization channel 115 may pass through a space between the first change part 132a and the second change part 132b and also pass through a space between the first change part 132a and the third change part 132c.

In the water treatment apparatus 3 according to an embodiment of the disclosure, because, while fluids pass through the deionization channel 115, a temperature of a fluid passing through the center area becomes lower than a temperature of a fluid passing through the side area that is close to the first electrode 111 or the second electrode 112, the flow changer 132 may guide the fluids such that the fluid passing through the center area of the deionization channel 115 is mixed with the fluid passing through the side area, thereby reducing a temperature difference between the fluids passing through the deionization channel 115.

Because the water treatment apparatus 3 according to an embodiment of the disclosure includes the flow changer 133 provided in the deionization channel 115, the water treatment apparatus 2 may reduce a difference between an ion concentration of a fluid passing through the area that is close to the cation exchange membrane 112c or the anion exchange membrane 111c and an ion concentration of a fluid passing through the area that is spaced from the cation exchange membrane 112c and the anion exchange membrane 111c. The flow changer 132 may reduce an ion concentration difference between fluids passing through the deionization channel 115 by mixing a fluid flowing through the center area of the deionization channel 115 with a fluid passing through the side area of the deionization channel 115 that is close to the first electrode 111 or a fluid passing through the side area of the deionization channel 115 that is close to the second electrode 112.

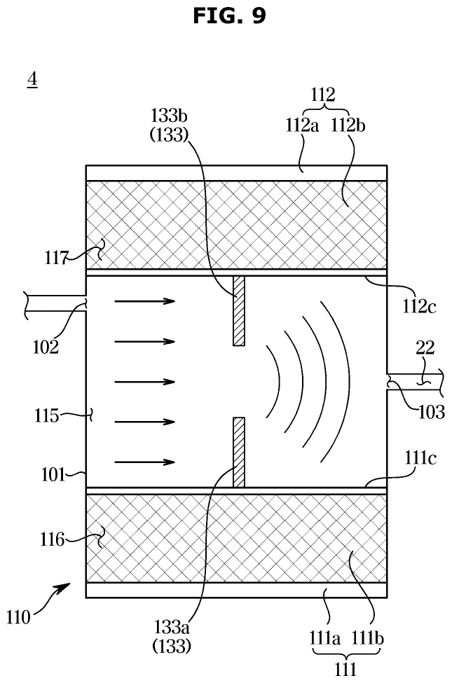

FIG. 9 is a conceptual view of a water treatment apparatus according to one or more embodiments of the disclosure.

A water treatment apparatus 4 according to an embodiment of the disclosure will be described with reference to FIG. 9. The same components as those of the water treatment apparatus 1 shown in FIG. 1 are assigned like reference numerals, and detailed descriptions thereof may be omitted.

Referring to FIG. 9, the water treatment apparatus 9 according to an embodiment of the disclosure may include a flow changer 133. The flow changer 133 may reduce a temperature difference between a temperature of a fluid passing through the area that is close to the first electrode 111 or the second electrode 112 and a temperature of a fluid passing through the area that is spaced from the first electrode 111 and the second electrode 112. The flow changer 133 may reduce a difference between a temperature of a fluid passing through the side area of the deionization channel 115 and a temperature of a fluid passing through the center area of the deionization channel 115.

The flow changer 133 according to an embodiment of the disclosure may mix a fluid passing through the center area of the deionization channel 115 with a fluid flowing through the side area of the deionization channel 115 that is close to the first electrode 111 or a fluid flowing through the side area of the deionization channel 115 that is close to the second electrode 112. The flow changer 133 may guide a fluid flowing through the center area of the deionization channel 115 to the side area of the deionization channel 115 that is close to the first electrode 111 or the side area of the deionization channel 115 that is close to the second electrode 112.

The flow changer 133 may change a linear flow of a fluid passing through the deionization channel 115 into a turbulent flow. The flow changer 133 may generate turbulence inside the deionization channel 115 while a fluid passes through the deionization channel 115.

The flow changer 133 according to an embodiment of the disclosure may be positioned inside the deionization channel 115. The flow changer 133 may include a first change part 133a positioned adjacent to the first electrode 111 and a second change part 133b positioned adjacent to the second electrode 112, inside the deionization channel 115.

The first change part 133a may extend from the first electrode 111 toward the second electrode 112. The first change part 133a may extend from the anion exchange membrane 111c. The first change part 133a may extend from the side area of the deionization channel 115 that is adjacent to the first electrode 111, toward the center area of the deionization channel 115. The first change part 133a may extend perpendicularly to the direction in which a fluid passes through the deionization channel 115.

The second change part 133b may extend from the second electrode 112 toward the first electrode 111. The second change part 133b may extend from the cation exchange membrane 112c. The second change part 133b may extend from the side area of the deionization channel 115 that is adjacent to the second electrode 112, toward the center area of the deionization channel 115. The second change part 133b may extend perpendicularly to the direction in which a fluid passes through the deionization channel 115.

A fluid passing through the deionization channel 115 may pass through a space formed between the first change part 133a and the second change part 133b. Among fluids passing through the deionization channel 115, a fluid passing through the side area that is adjacent to the first electrode 111 and a fluid passing through the side area that is adjacent to the second electrode 112 may be guided to the center area of the deionization channel 115 by the flow changer 133. A fluid passing through the side areas of the deionization channel 115 and a fluid passing through the center area may be mixed by passing through the space formed between the first change part 133a and the second change part 133b.

For example, the flow changer 133 may include a heat resistant material. The flow changer 133 may include a material capable of withstanding a temperature of water that passes through the deionization channel 115 and is heated. For example, the flow changer 133 may include a material that does not dissolve in water (i.e., a water-insoluble material). For example, the flow changer 133 may have a plate shape or a bar shape.

In the water treatment apparatus 4 according to an embodiment of the disclosure, because, while fluids pass through the deionization channel 115, a temperature of a fluid passing through the center area becomes lower than a temperature of a fluid passing through the side area that is close to the first electrode 111 or the second electrode 112, the flow changer 133 may guide the fluids such that the fluid passing through the center area of the deionization channel 115 is mixed with the fluid passing through the side area, thereby reducing a temperature difference between the fluids passing through the deionization channel 115.

Because the water treatment apparatus 4 according to an embodiment of the disclosure includes the flow changer 133 provided in the deionization channel 115, the water treatment apparatus 2 may reduce a difference between an ion concentration of a fluid passing through the area that is close to the cation exchange membrane 112c or the anion exchange membrane 111c and an ion concentration of a fluid passing through the area that is spaced from the cation exchange membrane 112c and the anion exchange membrane 111c. The flow changer 133 may reduce an ion concentration difference between fluids passing through the deionization channel 115 by mixing a fluid flowing through the center area of the deionization channel 115 with a fluid passing through the side area of the deionization channel 115 that is close to the first electrode 111 or a fluid passing through the side area of the deionization channel 115 that is close to the second electrode 112.

The flow changer 133 may be implemented in various shapes, including, but not limited to those illustrated in FIGS. 7-9. For example, the flow changer 133 may take the form of a perforated plate to enhance turbulence while minimizing flow resistance, a bar-shape structure to streamline fluid flow, a triangular fin shape to promote lateral mixing, or a helical structure configured to induce turbulent flow.

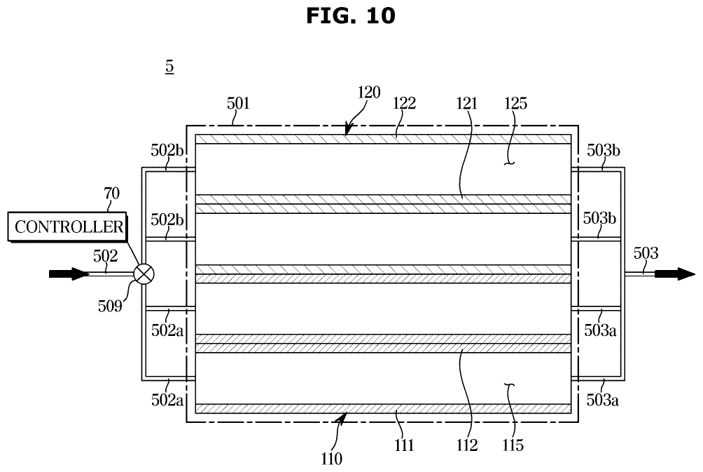

FIG. 10 is a conceptual view of a water treatment apparatus according to one or more embodiments of the disclosure.

A water treatment apparatus 5 according to an embodiment of the disclosure will be described with reference to FIG. 10. The same components as those of the water treatment apparatus 1 shown in FIG. 1 are assigned like reference numerals, and detailed descriptions thereof may be omitted.

Referring to FIG. 10, the water treatment apparatus 5 according to an embodiment of the disclosure may include an ion removing device 501. The ion removing device 501 may include at least one first ion removing module 110 and at least one second ion removing module 120. The at least one first ion removing module 110 may have the same configuration as the ion removing module 110 shown in FIG. 1.

The at least one second ion removing module 120 may have substantially the same configuration as the ion removal module 110 shown in FIG. 1. For example, in the at least one second ion removing module 120, a material of a third current collector of a third electrode 121 and/or a fourth current collector of a fourth electrode 122 may be different from the material of the first current collector 111a of the first electrode 111 and the second current collector 112a of the second electrode 112 of the ion removing module 110 shown in FIG. 1.

In the at least one ion removing module 120 according to an embodiment of the disclosure, the third current collector of the third electrode 121 and/or the fourth current collector of the fourth electrode 122 may include a material that has, even while a voltage is applied thereto, low heating performance or no heating performance compared to the first current collector 111a of the first electrode 111 and the second current collector 112a of the second electrode 112 of the ion removing module 110 shown in FIG. 1. For example, the third current collector of the third electrode 121 and/or the fourth current collector of the fourth electrode 122 of the second ion removing module 120 may include at least one selected from among aluminum, nickel, copper, titanium, iron, stainless steel, or graphite.

The at least one first ion removing module 110 may include a first deionization channel 115 formed between the first electrode 111 and the second electrode 112. The at least one second ion removing module 120 may include a second deionization channel 125 formed between the third electrode 121 and the fourth electrode 122.

According to this configuration, the water treatment apparatus 5 according to an embodiment of the disclosure may be configured to heat a fluid passing through the at least one first ion removing module 110 and not heat a fluid passing through the at least second ion removing module 120. For example, a fluid passing through the first deionization channel 115 of the at least one first ion removing module 110 may be heated as the first electrode 111 and/or the second electrode 112 generates heat, and a fluid passing through the second deionization channel 125 of the at least one second ion removing module 120 may not be heated as the third electrode 121 and/or the fourth electrode 122 do not generate heat.

In the water treatment apparatus 5 according to an embodiment of the disclosure, the at least one first ion removing module 110 and the at least one second ion removing module 120 may be arranged vertically. For example, the at least one second ion removing module 120 may be stacked on the at least one first ion removing module 110. Referring to FIG. 10, the water treatment apparatus 5 according to an embodiment of the disclosure is shown as having two second ion removing modules 120 arranged on two first ion removing modules 110, but is not limited thereto. However, the water treatment apparatus 5 may have the first ion removing modules 110 and the second ion removing modules 120 arranged alternately.

The water treatment apparatus 5 according to an embodiment of the disclosure may include an apparatus inlet 502 through which a fluid flows into the water treatment apparatus 5, and an apparatus outlet 503 through which a fluid is discharged from the water treatment apparatus 5. A fluid that has flowed into the water treatment apparatus 5 through the apparatus inlet 502 may be discharged from the water treatment apparatus 5 through the apparatus outlet 503.

The water treatment apparatus 5 according to an embodiment of the disclosure may include module inlets 502a and 502b for guiding a fluid flowed into the water treatment apparatus 5 through the apparatus inlet 502 to the at least one first ion removing module 110 and the at least one second ion removing module 120. The module inlets 502a and 502b may correspond to the ion removing modules 110 and 120. For example, the module inlets 502a and 502b may include at least one first module inlet 502a for the at least one first ion removing module 110, and at least one second module inlet 502b for the at least one second ion removing module 120.

The water treatment apparatus 5 according to an embodiment of the disclosure may include module outlets 503a and 503b for guiding a fluid discharged from the ion removing modules 110 and 120 to the apparatus outlet 503. The module outlets 503a and 503b may correspond to the ion removing modules 110 and 120. For example, the module outlets 503a and 503b may include at least one first module outlet 503a for the at least one first ion removing module 110, and at least one second module outlet 503b for the at least one second ion removing module 120.

In various embodiments, the apparatus inlet 502, the apparatus outlet 503, the module inlets 502a and 502b, and/or the module outlets 503a and 503b may be guides for guiding a fluid. The apparatus inlet 502, the apparatus outlet 503, the module inlets 502a and 502b, and/or the module outlets 503a and 503b may include a pipe for guiding a fluid. In various embodiments, the apparatus inlet 502, the apparatus outlet 503, the module inlets 502a and 502b, and/or the module outlets 503a and 503b may include a hose for guiding a fluid. In various embodiments, the apparatus inlet 502, the apparatus outlet 503, the module inlets 502a and 502b, and/or the module outlets 503a and 503b may include a duct for guiding a fluid. In various embodiments, the apparatus inlet 502, the apparatus outlet 503, the module inlets 502a and 502b, and/or the module outlets 503a and 503b may include a tube for guiding a fluid. In various embodiments, the apparatus inlet 502, the apparatus outlet 503, the module inlets 502a and 502b, and/or the module outlets 503a and 503b may include a conduit for guiding a fluid. In various embodiments, the apparatus inlet 502, the apparatus outlet 503, the module inlets 502a and 502b, and/or the module outlets 503a and 503b may include an extension member extending to guide a fluid. In various embodiments, the apparatus inlet 502, the apparatus outlet 503, the module inlets 502a and 502b, and/or the module outlets 503a and 503b may include a connecting member connecting two components to guide a fluid. In various embodiments, the apparatus inlet 502, the apparatus outlet 503, the module inlets 502a and 502b, and/or the module outlets 503a and 503b may include a line for guiding a fluid.

The water treatment apparatus 5 may include a path adjuster 509 for guiding a fluid flowed into the water treatment apparatus 5 through the apparatus inlet 502 to the module inlets 502a and 502b. The path adjuster 509 may guide a fluid flowed into the water treatment apparatus 5 through the apparatus inlet 502 to the first module inlet 502a and/or the second module inlet 502b. For example, the path adjuster 509 may include a valve or a switch.

Referring to FIG. 10, the water treatment apparatus 5 according to an embodiment of the disclosure may adjust a temperature of water that is discharged from the ion removing module 501 by adjusting a voltage that is applied to the ion removing module 501.

For example, the controller 70 of the water treatment apparatus 5 may control the path adjuster 509 to guide water flowed into the water treatment apparatus 5 to the first module inlet 502a, thereby providing soft water having a relatively high temperature. For example, the controller 70 may control the path adjuster 509 to guide water flowed into the water treatment apparatus 5 to some first module inlets 502a of a plurality of module inlets 502a, thereby adjusting an amount of high-temperature soft water that is provided.

For example, the controller 70 of the water treatment apparatus 5 may control the path adjuster 509 to guide water flowed into the water treatment apparatus 5 to the second module inlet 502b, thereby providing soft water having a relatively low temperature. For example, the controller 70 may control the path adjuster 509 to guide water flowed into the water treatment apparatus 5 to some second module inlets 502b of a plurality of module inlets 502b, thereby adjusting an amount of low-temperature soft water that is provided.

For example, the controller 70 of the water treatment apparatus 5 may control the path adjuster 509 to guide a part of water flowed into the water treatment apparatus 5 to the first module inlet 502a and guide another part of the water to the second module inlet 502b, thereby providing soft water having a relatively intermediate temperature. For example, the controller 70 may control the path adjuster 509 to guide a part of water flowed into the water treatment apparatus 5 to two first module inlets 502a and guide another part of the water to one second module inlet 502b, thereby adjusting a temperature of soft water that is provided. For example, the controller 70 may adjust the path adjuster 509 to guide a part of water flowed into the water treatment apparatus 5 to one first module inlet 502a and guide another part of the water to two second module inlets 502b, thereby adjusting a temperature of soft water that is provided.

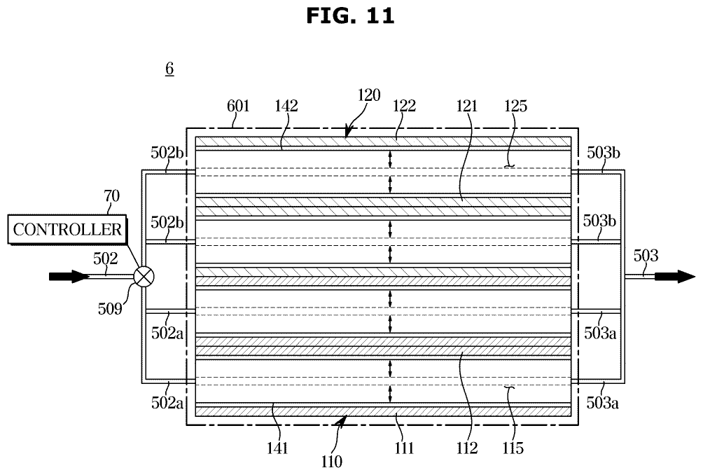

FIG. 11 is a conceptual view of a water treatment apparatus according to one or more embodiments of the disclosure.

A water treatment apparatus 6 according to an embodiment of the disclosure will be described with reference to FIG. 11. The same components as those of the water treatment apparatus 1 shown in FIG. 1 and those of the water treatment apparatus 5 shown in FIG. 10 are assigned like reference numerals, and detailed descriptions thereof may be omitted.

Referring to FIG. 11, the water treatment apparatus 6 may include flow path adjustors 141 and 142. The flow path adjustors 141 and 142 may be configured to adjust sizes of the deionization channels 115 and 125. The flow path adjustors 141 and 142 may be provided in an ion removing device 601. The flow path adjustors 141 and 142 may include a first flow path adjustor 141 provided in the at least one first ion removing module 110 and a second flow path adjustor provided in the at least one second ion removing module 120.

For example, the flow path adjustors 141 and 142 may include an electrostrictive material or a magnetostrictive material. The electrostrictive material may include a ceramic material such as PZT, and while current is applied to the electrostrictive material, the electrostrictive material may be deformed in size. Therefore, while a voltage is applied to the electrostrictive material, the electrostrictive material may expand in size to reduce the sizes of the deionization channels 115 and 125. The magnetostrictive material may include a material, such as nickel, an alloy of iron and cobalt, an alloy of iron and aluminum, and zinc ferrite, and the magnetostrictive material may expand and contract in size depending on whether magnetism is applied to the magnetostrictive material, thereby adjusting the sizes of the deionization channels 115 and 125 as described above.

However, the flow path adjustors 141 and 142 are not limited to this configuration, and a part of the electrodes 111, 112, 121, and 122 may be configured with an electrostrictive material or a magnetostrictive material. For example, a part of the electrodes 111, 112, 121, and 122 may be provided in the form of a polymer having elasticity, such as a sponge.

In addition, the flow path adjustors 141 and 142 are not limited to this configuration, and may include a rod for adjusting the sizes of the deionization channels 115 and 125 and a driving member for operating the rod. For example, the driving member may include a solenoid for converting an electrical force into a mechanical motion, but is not limited thereto, and the driving member may include a hydraulic member or a pneumatic member.

According to this configuration, in the water treatment apparatus 6 according to an embodiment of the disclosure, the controller 70 may control the flow path adjustors 141 and 142 to adjust widths of the deionization channels 115 and 125, thereby adjusting flow rates of fluids passing through the ion removing modules 110 and 120.

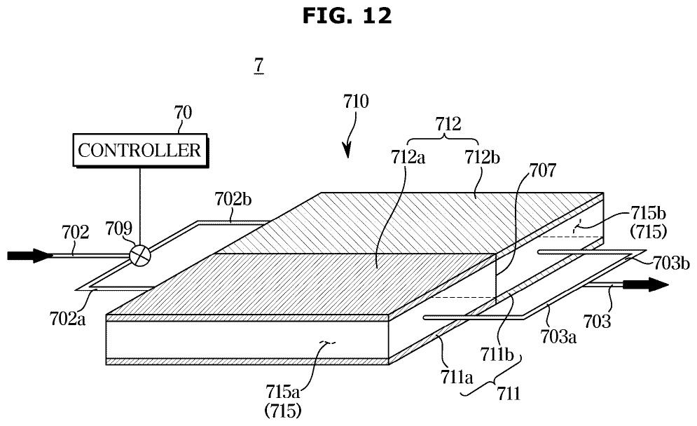

FIG. 12 is a conceptual view of a water treatment apparatus according to one or more embodiments of the disclosure.

A water treatment apparatus 7 according to an embodiment of the disclosure will be described with reference to FIG. 12. The same components as those of the water treatment apparatus 1 shown in FIG. 1 are assigned like reference numerals, and detailed descriptions thereof may be omitted.

Referring to FIG. 12, the water treatment apparatus 7 may include an apparatus inlet 702 through which a fluid flows into the water treatment apparatus 7, an apparatus outlet 703 through which a fluid is discharged from the water treatment apparatus 7, and an ion removing module 710 for changing hard water flowed into the water treatment apparatus 7 through the apparatus inlet 702 to soft water.

The ion removing module 710 shown in FIG. 12 may have a similar configuration to the ion removing module 110 shown in FIG. 1. For example, the ion removing module 710 may include a first electrode 711, a second electrode 712, a deionization channel 715, a cation exchange membrane, and an anion exchange membrane.

Referring to FIG. 12, the first electrode 711 of the ion removing module 710 according to an embodiment of the disclosure may include a first electrode part 711a and a second electrode part 711b. The first electrode part 711a and the second electrode part 711b may include different materials. The first electrode part 711a and the second electrode part 711b may be arranged perpendicularly to a direction in which a fluid passes through the deionization channel 715 of the ion removing module 710. The first electrode part 711a may have the same area as the second electrode part 711b.

For example, the first electrode part 711a may include a heating element, and the second electrode part 711b may not include a heating element. For example, the first electrode part 711a may include a material that has higher heating performance than the second electrode part 711b based on application of a voltage. For example, the first electrode part 711a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr, and the second electrode part 711b may include at least one metal or alloy selected from among aluminum, nickel, copper, titanium, iron, stainless steel, or graphite.

The second electrode 712 of the ion removing module 710 according to an embodiment of the disclosure may include a third electrode part 712a and a fourth electrode part 712b. The third electrode part 712a and the fourth electrode part 712b may include different materials. The third electrode part 712a and the fourth electrode part 712b may be arranged perpendicularly to the direction in which a fluid passes through the deionization channel 715 of the ion removing module 710. The third electrode part 712a may have the same area as the fourth electrode part 712b. The third electrode part 712a and the fourth electrode part 712b may correspond to the first electrode part 711a and the second electrode part 711b.

The third electrode part 712a may correspond to the first electrode part 711a. The third electrode part 712a may be the same as the first electrode part 711a. For example, the third electrode part 712a may include a heating element. For example, the third electrode part 712a may include a material capable of generating heat based on application of a voltage. For example, the third electrode part 712a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

The fourth electrode part 712b may correspond to the second electrode part 711b. The fourth electrode part 712b may be the same as the first electrode part 711b. For example, the fourth electrode part 712b may not include a heating element. For example, the fourth electrode part 712b may include a material having lower heating performance than the third electrode part 712a based on application of a voltage. For example, the fourth electrode part 712b may include at least one metal or alloy selected from among aluminum, nickel, copper, titanium, iron, stainless steel, or graphite.

The deionization channel 715 of the ion removing module 710 may include a first deionization channel 715a formed by the first electrode part 711a and the third electrode part 712a, and a second deionization channel 715b formed by the second electrode part 711b and the fourth electrode part 712b.

The ion removing module 710 may include a partition wall 707 that partitions the first deionization channel 715a from the second deionization channel 715b. Due to the partition wall 707, a fluid passing through the first deionization channel 715a may not be mixed with a fluid passing through the second deionization channel 715b. The partition wall 707 may extend in a direction in which a fluid passing through the ion removing module 710 flows along the deionization channel 715.

The water treatment apparatus 7 according to an embodiment of the disclosure may include the apparatus inlet 702 through which a fluid flows into the water treatment apparatus 7, and the apparatus outlet 703 through which a fluid is discharged from the water treatment apparatus 7.

The water treatment apparatus 7 according to an embodiment of the disclosure may include module inlets 702a and 702b for respectively guiding a fluid flowed into the water treatment apparatus 7 through the apparatus inlet 702 to the first deionization channel 715a and the second deionization channel 715b. For example, the module inlets 702a and 702b may include a first module inlet 702a for the first deionization channel 715a, and a second module inlet 702b for the second deionization channel 715b.

The water treatment apparatus 7 according to an embodiment of the disclosure may include module outlets 703a and 703b for guiding a fluid discharged from the deionization channel 715 to the apparatus outlet 703. For example, the module outlets 703a and 703b may include a first module outlet 703a for the first deionization channel 715a, and a second module outlet 703b for the second deionization channel 715b.

The water treatment apparatus 7 may include a path adjuster 709 for guiding a fluid flowed into the water treatment apparatus 7 through the apparatus inlet 702 to the module inlets 702a and 702b. The path adjuster 709 may guide a fluid flowed into the water treatment apparatus 7 through the apparatus inlet 702 to the first module inlet 702a and/or the second module inlet 702b. For example, the path adjuster 709 may include a valve or a switch.

Referring to FIG. 12, the water treatment apparatus 7 according to an embodiment of the disclosure may adjust a temperature of water that is discharged from the ion removing module 710 by adjusting a voltage that is applied to the water treatment apparatus 7.

For example, the controller 70 of the water treatment apparatus 7 may control the path adjuster 709 to guide water flowed into the water treatment apparatus 7 to the first module inlet 702a, thereby providing soft water having a relatively high-temperature.

For example, the controller 70 of the water treatment apparatus 7 may control the path adjuster 709 to guide water flowed into the water treatment apparatus 7 to the second module inlet 702b, thereby providing soft water having a relatively low-temperature.

For example, the controller 70 of the water treatment apparatus 7 may control the path adjuster 509 to guide a part of water flowed into the water treatment apparatus 7 to the first module inlet 702a and guide another part of the water to the second module inlet 702b, thereby providing soft water having a relatively intermediate temperature.

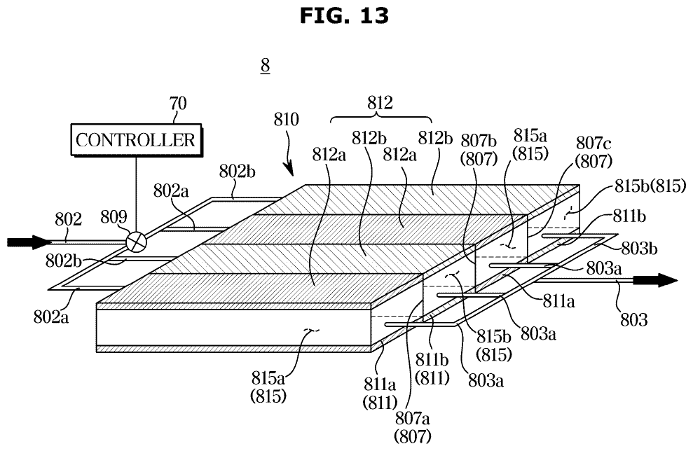

FIG. 13 is a conceptual view of a water treatment apparatus according to one or more embodiments of the disclosure.

A water treatment apparatus 8 according to an embodiment of the disclosure will be described with reference to FIG. 13. The same components as those of the water treatment apparatus 1 shown in FIG. 1 and those of the water treatment apparatus 7 shown in FIG. 12 are assigned like reference numerals, and detailed descriptions thereof may be omitted.

Referring to FIG. 13, the water treatment apparatus 8 may include an apparatus inlet 802 through which a fluid flows into the water treatment apparatus 8, an apparatus outlet 803 through which a fluid is discharged from the water treatment apparatus 8, and an ion removing module 810 for changing hard water flowed into the apparatus inlet 802 to soft water.

The ion removing module 810 shown in FIG. 13 may have a similar configuration to the ion removing module 110 shown in FIG. 1. For example, the ion removing module 810 may include a first electrode 811, a second electrode 812, a deionization channel 815, a cation exchange membrane, and an anion exchange membrane.

Referring to FIG. 13, the first electrode 811 of the ion removing module 810 according to an embodiment of the disclosure may include a first electrode part 811a and a second electrode part 811b. The first electrode part 811a and the second electrode part 811b may include different materials.

For example, the first electrode part 811a may include a heating element, and the second electrode part 811b may not include a heating element. For example, the first electrode part 811a may include a material having higher heating performance than the second electrode part 811b based on application of a voltage. For example, the first electrode part 811a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr or CoCr, and the second electrode part 811b may include at least one metal or alloy selected from aluminum, nickel, copper, titanium, iron, stainless steel, or graphite.

The first electrode part 811a according to an embodiment of the disclosure may include a plurality of pieces (e.g., a plurality of discrete electrode segments). For example, the first electrode part 811a may include two pieces arranged apart from each other in a flow direction of fluid through the deionization channel 815 of the ion removing module 810. The second electrode part 811b according to an embodiment of the disclosure may include a plurality of pieces (e.g., a plurality of discrete electrode segments). For example, the second electrode part 811b may include two electrode pieces arranged apart from each other in the direction in which a fluid passes through the deionization channel 815 of the ion removing module 810. However, the disclosure is not limited thereto, and the first electrode part 811a may include two or more pieces. Also, the second electrode part 811b may include two or more pieces.

The first electrode part 811a and the second electrode part 811b may be arranged perpendicularly to the direction in which a fluid passes through the deionization channel 115 of the ion removing module 810. The plurality of pieces of the first electrode part 811a and the plurality of pieces of the second electrode part 811b may be arranged alternately. For example, at one side of one piece of the first electrode part 811a, one piece of the second electrode part 811b may be positioned, and at another side of the second electrode part 811a, another piece of the first electrode part 811a may be positioned. At one side of another piece of the first electrode part 811a, another piece of the second electrode part 811b may be positioned.

The first electrode part 811a and the second electrode part 811b may have the same areas. For example, the plurality of pieces of the first electrode part 811a may have the same areas. For example, the plurality of pieces of the second electrode part 811b may have the same areas. A sum of the areas of the plurality of pieces of the first electrode part 811a may be equal to a sum of the areas of the plurality of pieces of the second electrode part 811b.

The second electrode 812 of the ion removing module 810 according to an embodiment of the disclosure may include a third electrode part 812a and a fourth electrode part 812b. The third electrode part 812a and the fourth electrode part 812b may include different materials.

The third electrode part 812a may correspond to the first electrode part 811a. The third electrode part 812a may be the same as the first electrode part 811a. For example, the third electrode part 812a may include a heating element. For example, the third electrode part 812a may include a material capable of generating heat based on application of a voltage. For example, the third electrode part 812a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

The fourth electrode part 812b may correspond to the second electrode part 811b. The fourth electrode part 812b may be the same as the second electrode part 811b. For example, the fourth electrode part 812b may not include a heating element. For example, the fourth electrode part 812b may include a material having lower heating performance than the third electrode part 812a based on application of a voltage. For example, the fourth electrode part 812b may include at least one metal or alloy selected from among aluminum, nickel, copper, titanium, iron, stainless steel, or graphite.

The third electrode part 812a according to an embodiment of the disclosure may include a plurality of pieces (e.g., a plurality of discrete electrode segments). For example, the third electrode part 812a may include two electrode pieces spaced apart in the direction in which a fluid passes through the deionization channel 115 of the ion removing module 810, to correspond to the first electrode part 811a.

The fourth electrode part 812b according to an embodiment of the disclosure may include a plurality of pieces (e.g., a plurality of discrete electrode segments). For example, the fourth electrode part 812b may include two electrode pieces spaced apart in the direction in which a fluid passes through the deionization channel 815 of the ion removing module 810, to correspond to the second electrode part 811b, but is not limited thereto. The third electrode part 812a may include two or more pieces. Also, the fourth electrode part 812b may include two or more pieces.

The third electrode part 812a and the fourth electrode part 812b may be arranged perpendicularly to the direction in which a fluid passes through the deionization channel 815 of the ion removing module 810. The third electrode part 812a and the fourth electrode part 812b may be arranged to correspond to the first electrode part 811a and the second electrode part 811b. The plurality of pieces of the third electrode part 812a and the plurality of pieces of the fourth electrode part 812b may be arranged alternately. For example, at one side of one piece of the third electrode part 812a, one piece of the fourth electrode part 812b may be positioned, and at another side of the fourth electrode part 812a, another piece of the third electrode part 812a may be positioned. At one side of another piece of the third electrode part 812a, another piece of the fourth electrode part 812b may be positioned.

The third electrode part 812a and the fourth electrode part 812b may have the same areas. For example, the plurality of pieces of the third electrode part 812a may have the same areas. For example, the plurality of pieces of the fourth electrode part 812b may have the same areas. A sum of the areas of the plurality of pieces of the third electrode part 812a may be equal to a sum of the areas of the plurality of pieces of the fourth electrode part 812b.

The deionization channel 815 of the ion removing module 810 may include a first deionization channel 815a formed by the first electrode part 811a and the third electrode part 812a, and a second deionization channel 815b formed by the second electrode part 811b and the fourth electrode part 812b. For example, the first deionization channel 815a may include a plurality of channels to correspond to the plurality of pieces of the first electrode part 811a and the plurality of pieces of the third electrode part 812a. For example, the second deionization channel 815b may include a plurality of channels to correspond to the plurality of pieces of the second electrode part 811b and the plurality of pieces of the fourth electrode part 812b.

The ion removing module 810 may include a partition wall 807 that partitions the first deionization channel 815a from the second deionization channel 815b. Due to the partition wall 807, a fluid passing through the first deionization channel 815a may not be mixed with a fluid passing through the second deionization channel 815b. The partition wall 807 may extend in a direction in which a fluid passing through the ion removing module 810 flows along the deionization channel 815.

For example, the partition wall 807 may include a plurality of partition wall parts 807a, 807b, and 807c to partition the plurality of deionization channels 815 formed because each of the first electrode part 811a, the second electrode part 811b, the third electrode part 812a, and the fourth electrode part 812 includes a plurality of pieces (e.g., a plurality of discrete electrode segments). A first partition wall part 807a may be positioned between one of the plurality of first deionization channels 815a and one of the plurality of second deionization channels 815b, a second partition wall part 807b may be spaced from the first partition wall part 807a and positioned between one of the plurality of second deionization channels 815b and another one of the plurality of first deionization channels 815a, and a third partition wall part 807c may be spaced from the second partition wall part 807b and positioned between another one of the plurality of first deionization channels 815a and another one of the plurality of second deionization channels 815b.

The water treatment apparatus 8 according to an embodiment of the disclosure may include the apparatus inlet 802 through which a fluid flows into the water treatment apparatus 8 and the apparatus outlet 803 through which a fluid is discharged from the water treatment apparatus 8.

The water treatment apparatus 8 according to an embodiment of the disclosure may include module inlets 802a and 802b for respectively guiding a fluid flowed into the water treatment apparatus 8 through the apparatus inlet 802 to the first deionization channels 815a and the second deionization channels 815b. For example, the module inlets 802a and 802b may include a first module inlet 802a for the first deionization channel 815a, and a second module inlet 802b for the second deionization channel 815b. For example, a plurality of first module inlets 802a may be provided to correspond to the first deionization channels 815a. For example, a plurality of second module inlets 802b may be provided to correspond to the second deionization channels 815b.

The water treatment apparatus 8 according to an embodiment of the disclosure may include module outlets 803a and 803b for guiding a fluid discharged from the deionization channel 815 to the apparatus outlet 803. For example, the module outlets 803a and 803b may include a first module outlet 803a for the first deionization channel 815a, and a second module outlet 803b for the second deionization channels 815b. For example, a plurality of first module outlets 803a may be provided to correspond to the first deionization channels 815a. For example, a plurality of second module outlets 803b may be provided to correspond to the second deionization channels 815b.

The water treatment apparatus 8 may include a path adjuster 809 for guiding a fluid flowed into the water treatment apparatus 8 through the apparatus inlet 802 to the module inlets 802a and 802b. The path adjuster 809 may guide a fluid flowed into the water treatment apparatus 8 through the apparatus inlet 802 to the first module inlet 802a and/or the second module inlet 802b. For example, the path adjuster 809 may include a valve or a switch.

Referring to FIG. 13, the water treatment apparatus 8 according to an embodiment of the disclosure may adjust a temperature of water that is discharged from the ion removing module 810 by adjusting a voltage that is applied to the water treatment apparatus 8.

For example, the controller 70 of the water treatment apparatus 8 may control the path adjuster 809 to guide water flowed into the water treatment apparatus 8 to the first module inlet 802a, thereby providing soft water having a relatively high temperature.

For example, the controller 70 of the water treatment apparatus 8 may control the path adjuster 809 to guide water flowed into the water treatment apparatus 8 to the second module inlet 802b, thereby providing soft water having a relatively low temperature.

For example, the controller 70 of the water treatment apparatus 8 may control the path adjuster 809 to guide a part of water flowed into the water treatment apparatus 8 to the first module inlet 802a and guide another part of the water to the second module inlet 802b, thereby providing soft water having a relatively intermediate temperature.

For example, the controller 70 of the water treatment apparatus 8 may control the path adjuster 809 to guide a part of water flowed into the water treatment apparatus 8 to at least a part of the plurality of first module inlets 802a and guide another part of the water to at least a part of the second module inlets 802b, thereby more variously adjusting a temperature of soft water that is provided.

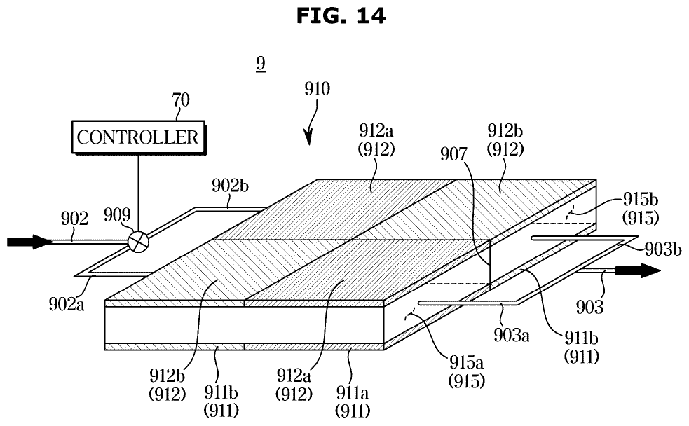

FIG. 14 is a conceptual view of a water treatment apparatus according to one or more embodiments of the disclosure.

A water treatment apparatus 9 according to an embodiment of the disclosure will be described with reference to FIG. 14. The same components as those of the water treatment apparatus 1 shown in FIG. 1, those of the water treatment apparatus 7 shown in FIG. 12, and those of the water treatment apparatus 8 shown in FIG. 13 are assigned like reference numerals, and detailed descriptions thereof may be omitted.

Referring to FIG. 14, the water treatment apparatus 9 may include an apparatus inlet 902 through which a fluid flows into the water treatment apparatus 9, an apparatus outlet 903 through which a fluid is discharged from the water treatment apparatus 9, and an ion removing module 910 for changing hard water flowed into the apparatus inlet 902 to soft water.

The ion removing module 910 shown in FIG. 14 may have a similar configuration to the ion removing module 110 shown in FIG. 1. For example, the ion removing module 910 may include a first electrode 911, a second electrode 912, a deionization channel 915, a cation exchange membrane, and an anion exchange membrane.

Referring to FIG. 14, the first electrode 911 of the ion removing module 910 according to an embodiment of the disclosure may include a first electrode part 911a and a second electrode part 911b. The first electrode part 911a and the second electrode part 911b may include different materials.

For example, the first electrode part 911a may include a heating element, and the second electrode part 911b may not include a heating element. For example, the first electrode part 911a may include a material that has higher heating performance than the second electrode part 911b based on application of a voltage. For example, the first electrode part 911a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr, and the second electrode part 911b may include at least one metal or alloy selected from among aluminum, nickel, copper, titanium, iron, stainless steel, or graphite.

The first electrode part 911a according to an embodiment of the disclosure may include a plurality of pieces (e.g., a plurality of discrete electrode segments). For example, the first electrode part 911a may include two electrode pieces spaced apart from each other in a direction inclined with respect to a flow direction of fluid through the deionization channel 915 of the ion removing module 910. The second electrode part 911b according to an embodiment of the disclosure may include a plurality of pieces (e.g., a plurality of discrete electrode segments). For example, the second electrode part 911b may include two electrode pieces spaced apart from each other in a direction inclined with respect to the flow direction of fluid through the deionization channel 915 of the ion removing module 910.

For example, the plurality of pieces of the first electrode part 911a and the plurality of pieces of the second electrode part 911b may be arranged in a lattice form. One piece of the first electrode part 911a may be arranged with one piece of the second electrode part 911b in the direction in which a fluid passes through the deionization channel 915 of the ion removing module 910, and with another piece of the second electrode part 911b in a direction that is perpendicular to the direction in which a fluid passes through the deionization channel 915 of the ion removing module 910. One piece of the second electrode part 911b may be arranged with one piece of the first electrode part 911a in the direction in which a fluid passes through the deionization channel 915 of the ion removing module 910, and with another piece of the first electrode part 911a in the direction that is perpendicular to the direction in which a fluid passes through the deionization channel 915 of the ion removing module 910. However, the disclosure is not limited to this arrangement, and the plurality of pieces of the first electrode part 911a and the plurality of pieces of the second electrode part 911b may be arranged in various shapes.

The first electrode part 911a may have the same area as the second electrode part 911b. For example, the plurality of pieces of the first electrode part 911a may have the same areas. For example, the plurality of pieces of the second electrode part 911b may have the same areas. A sum of the areas of the plurality of pieces of the first electrode part 911a may be equal to a sum of the areas of the plurality of pieces of the second electrode part 911b.

The second electrode 912 of the ion removing module 910 according to an embodiment of the disclosure may include a third electrode part 912a and a fourth electrode part 912b. The third electrode part 912a and the fourth electrode part 912b may include different materials.

The third electrode part 912a may correspond to the first electrode part 911a. The third electrode part 912a may be the same as the first electrode part 911a. For example, the third electrode part 912a may include a heating element. For example, the third electrode part 912a may include a material capable of generating heat based on application of a voltage. For example, the third electrode part 912a may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

The fourth electrode part 912b may correspond to the second electrode part 911b. The fourth electrode part 912b may be the same as the second electrode part 911b. For example, the fourth electrode part 912b may not include a heating element. For example, the fourth electrode part 912b may include a material having lower heating performance than the third electrode part 912a based on application of a voltage. For example, the fourth electrode part 912b may include at least one metal or alloy selected from among aluminum, nickel, copper, titanium, iron, stainless steel, or graphite.

The third electrode part 912a according to an embodiment of the disclosure may include a plurality of pieces (e.g., a plurality of discrete electrode segments). For example, the third electrode part 912a may include two electrode pieces spaced apart in the direction inclined with respect to the direction in which a fluid passes through the deionization channel 915 of the ion removing module 910, to correspond to the first electrode part 911a.

The fourth electrode part 912b according to an embodiment of the disclosure may include a plurality of pieces (e.g., a plurality of discrete electrode segments). For example, the fourth electrode part 912b may include two electrode pieces spaced apart in the direction inclined with respect to the direction in which a fluid passes through the deionization channel 915 of the ion removing module 810, to correspond to the second electrode part 911b.

For example, the plurality of pieces of the third electrode part 912a and the plurality of pieces of the fourth electrode part 912b may be arranged in a lattice form. One piece of the third electrode part 912a may be arranged with one piece of the fourth electrode part 912b in the direction in which a fluid passes through the deionization channel 915 of the ion removing module 910, and with another piece of the fourth electrode part 912b in the direction that is perpendicular to the direction in which a fluid passes through the deionization channel 915 of the ion removing module 910. One piece of the fourth electrode part 912b may be arranged with one piece of the third electrode part 912a in the direction in which a fluid passes through the deionization channel 915 of the ion removing module 910, and with another piece of the third electrode part 912a in the direction that is perpendicular to the direction in which a fluid passes through the deionization channel 915 of the ion removing module 910.

The third electrode part 912a and the fourth electrode part 912b may have the same areas. For example, the plurality of pieces of the third electrode part 912a may have the same areas. For example, the plurality of pieces of the fourth electrode part 912b may have the same areas. A sum of the areas of the plurality of pieces of the third electrode part 912a may be equal to a sum of the areas of the plurality of pieces of the fourth electrode part 912b.

The deionization channel 915 of the ion removing module 910 may include a first deionization channel 915a formed by one piece of the first electrode part 911a, one piece of the second electrode part 911b, one piece of the third electrode part 912a, and one piece of the fourth electrode part 912b, and a second deionization channel 915b formed by another piece of the first electrode part 911a, another piece of the second electrode part 911b, another piece of the third electrode part 912a, and another piece of the fourth electrode part 912b.

The ion removing module 910 may include a partition wall 907 that partitions the first deionization channel 915a from the second deionization channel 915b. Due to the partition wall 907, a fluid passing through the first deionization channel 915a may not be mixed with a fluid passing through the second deionization channel 915b. The partition wall 907 may extend in a direction in which a fluid passing through the ion removing module 910 flows along the deionization channel 915.

The water treatment apparatus 9 according to an embodiment of the disclosure may include the apparatus inlet 902 through which a fluid flows into the water treatment apparatus 9, and the apparatus outlet 903 through which a fluid is discharged from the water treatment apparatus 9.

The water treatment apparatus 9 according to an embodiment of the disclosure may include module inlets 902a and 902b for respectively guiding a fluid flowed into the water treatment apparatus 9 through the apparatus inlet 902 to the first deionization channel 915a and the second deionization channel 915b. For example, the module inlets 902a and 902b may include a first module inlet 902a for the first deionization channel 915a, and a second module inlet 902b for the second deionization channel 915b.

The water treatment apparatus 9 according to an embodiment of the disclosure may include module outlets 903a and 903b for guiding a fluid discharged from the deionization channel 915 to the apparatus outlet 903. For example, the module outlets 903a and 903b may include a first module outlet 903a for the first deionization channel 915a, and a second module outlet 903b for the second deionization channel 915b. For example, a plurality of first module outlet 903a may be provided to correspond to the first deionization channel 915a. For example, a plurality of second module outlets 903b may be provided to correspond to the second deionization channel 915b.

The water treatment apparatus 9 may include a path adjuster 909 for guiding a fluid flowed into the water treatment apparatus 9 through the apparatus inlet 902 to the module inlets 902a and 902b. The path adjuster 909 may guide a fluid flowed into the water treatment apparatus 9 through the apparatus inlet 902 to the first module inlet 902a and/or the second module inlet 902b. For example, the path adjuster 909 may include a valve or a switch.

Referring to FIG. 14, the water treatment apparatus 9 according to an embodiment of the disclosure may adjust a temperature of water that is discharged from the ion removing module 910 by adjusting a voltage that is applied to the water treatment apparatus 9.

For example, the controller 70 of the water treatment apparatus 9 may control the path adjuster 909 to guide water flowed into the water treatment apparatus 9 to the first module inlet 902a, thereby adjusting a temperature of soft water that is provided.

For example, the controller 70 of the water treatment apparatus 9 may control the path adjuster 909 to guide water flowed into the water treatment apparatus 9 to the second module inlet 902b, thereby adjusting a temperature of soft water that is provided.

For example, the controller 70 of the water treatment apparatus 9 may adjust the path adjuster 909 to guide a part of water flowed into the water treatment apparatus 9 to the first module inlet 902a and guide another part of the water to the second module inlet 902b, thereby adjusting a temperature of soft water that is provided.

Although the water treatment apparatuses 1, 2, 3, 4, 5, 6, 7, 8, and 9 according to various embodiments of the disclosure have been described with reference to FIGS. 1 to 14, the concept of the disclosure is not limited thereto, and may further include combined embodiments of the above-described embodiments. For example, the flow changer 131 of the water treatment apparatus 2 shown in FIG. 7 may be applied to the water treatment apparatus 5 shown in FIG. 10 or the water treatment apparatus 7 shown in FIG. 12.

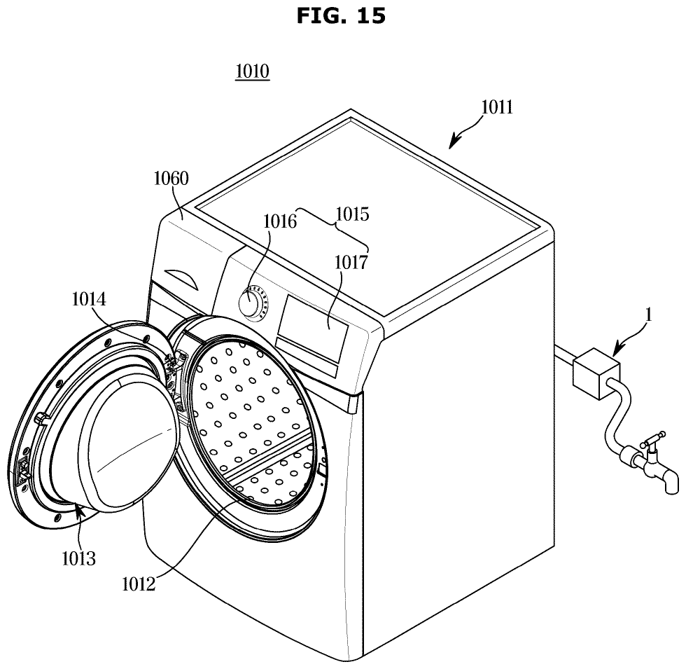

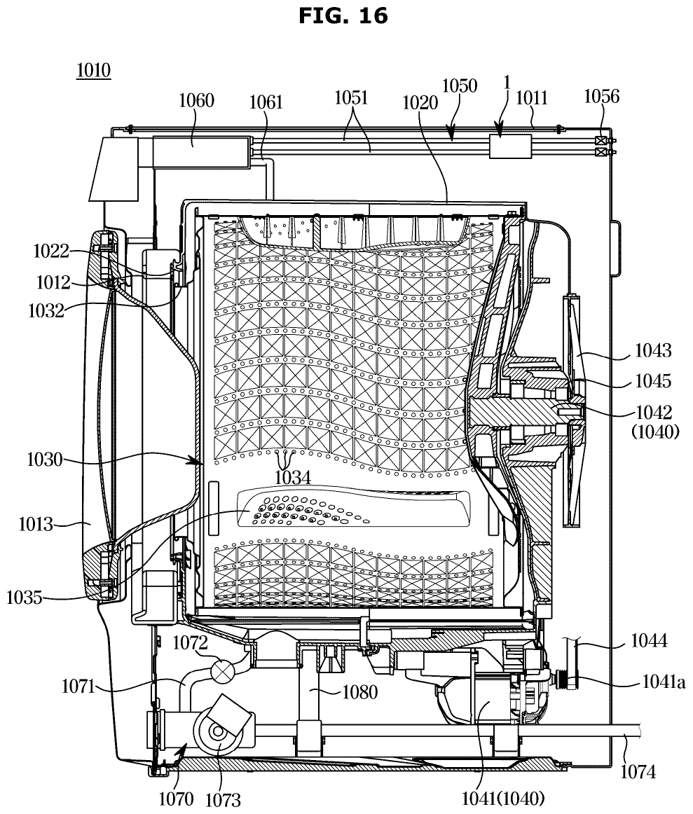

FIG. 15 shows a washing machine to which a water treatment apparatus according to one or more embodiments of the disclosure is connected. FIG. 16 shows a cross section of a washing machine to which a water treatment apparatus according to one or more embodiments of the disclosure is applied.

A washing machine 1010 to which the water treatment apparatus 1 according to an embodiment of the disclosure is connected and/or applied will be described with reference to FIGS. 15 and 16. The water treatment apparatus 1 may be incorporated into the washing machine 1010 or provided as a separate unit that may be connected to the washing machine 1010.

The washing machine 1010 may include a washing machine housing 1011 that accommodates various components therein. The washing machine housing 1011 may form an appearance of the washing machine 1010. The washing machine housing 1011 may have a box shape of which one side opens.

The washing machine housing 1011 may include a housing opening 1012 formed to allow access to inside of a drum 1030. The housing opening 1012 may open substantially forward.

The washing machine 1010 may include a door 1013 for opening or closing the housing opening 1012 provided in the washing machine housing 1011. The door 1013 may be rotatably mounted on the washing machine housing 1011 by a hinge 1014. At least one portion of the door 1013 may be transparent or translucent to show inside of the washing machine housing 1011.

The washing machine 1010 may include a tub 1020 provided inside the washing machine housing 1011 to store water. The tub 1020 may be positioned inside the washing machine housing 1011. The tub 1020 may include a tub opening 1022 corresponding to the housing opening 1012. The tub opening 1022 may open substantially forward. The tub 1020 may be supported inside the washing machine housing 1011. The tub 1020 may have a substantially cylindrical shape of which one side opens.

The tub 1020 may be elastically supported from the washing machine housing 1011 by a damper 1080. The damper 1080 may connect the tub 1020 to the washing machine housing 1011. The damper 1080 may attenuate vibrations generated during a rotation of the drum 1030 by absorbing vibration energy between the tub 1020 and the washing machine housing 1011 upon transferring of the vibrations to the tub 1020 and/or the washing machine housing 1011.

The washing machine 1010 may include a drum 1030 that accommodates laundry. The drum 1030 may be rotatably provided inside the tub 1020. The drum 1030 may perform washing, rinsing, and/or dehydrating, while rotating inside the tub 1020. The drum 1030 may include a through hole 1034 that connects an inside space of the drum 1030 with an inside space of the tub 1020. The drum 1030 may have a substantially cylindrical shape of which one side opens. On an inner circumferential surface of the drum 1030, at least one lifter 1035 may be provided to lift and drop laundry upon a rotation of the drum 1030.

The drum 1030 may include a drum opening 1032 corresponding to the housing opening 1012 and the tub opening 1022. Laundry may be put into the drum 1030 or taken out of the drum 1030 through the housing opening 1012, the tub opening 1022, and the drum opening 1032.

The washing machine 1010 may include a washing machine driver 1040 configured to rotate the drum 1030. The washing machine driver 1040 may include a driving motor 1041, and a rotation shaft 1042 for transferring a driving force generated in the driving motor 1041 to the drum 1030. The rotation shaft 1042 may penetrate the tub 1020 and be connected to the drum 1030.

The washing machine 1010 may be classified into a direct driving type in which the rotation shaft 1042 is directly connected to the driving motor 1041 to rotate the drum 1030, and an indirect driving type in which a pulley 1043 is connected between the driving motor 1041 and the rotation shaft 1042 to drive the drum 1030.

The washing machine 1010 according to an embodiment may be, but is not limited thereto, an indirect driving type. However, the washing machine 1010 according to an embodiment may be a direct driving type.

One end of the rotation shaft 1042 may be connected to the drum 1030, and another end of the rotation shaft 1042 may be connected to the pulley 1043 to receive power from the driving motor 1041. At a rotation shaft of the driving motor 1041, a motor pulley 1041a may be formed. A driving belt 1044 may be provided between the motor pulley 1041a and the pulley 1043 such that the rotation shaft 1042 operates by the driving belt 1044.

In a rear portion of the tub 1020, a bearing housing 1045 may be installed to rotatably support the rotation shaft 1042. The bearing housing 1045 may be formed of an aluminum alloy, and may be inserted into the rear portion of the tub 1020 upon injection-molding of the tub 1020.

The washing machine driver 1040 may rotate the drum 1030 forward or backward to perform washing, rinsing, and/or dehydrating or drying operation.

The washing machine 1010 may include a water supply device 1050. The water supply device 1050 may supply water to the tub 1020. The water supply device 1050 may be positioned above the tub 1020. The water supply device 1050 may include a water supply tube 1051, and a water supply valve 1056 provided in the water supply tube 1051. The water supply tube 1051 may be connected to an external water supply source. The water supply tube 1051 may extend to a detergent supply device 1960 and/or the tub 1020 from the external water supply source. Water may be supplied to the tub 1020 via the detergent supply device 1060. Water may be supplied to the tub 1020 not via the detergent supply device 1060.

The water supply valve 1056 may open or close the water supply tube 1051 in response to an electrical signal from a controller. The water supply valve 1056 may allow or block supply of water from the external water supply source to the tub 1020. The water supply valve 1056 may include, for example, a solenoid valve that is opened or closed in response to an electrical signal.

The washing machine 1010 may include the detergent supply device 1060 configured to supply a detergent to the tub 1020. The detergent supply device 1060 may supply a detergent to the inside of the tub 1020 during a water supply process. Water supplied through the water supply tube 1051 may be mixed with a detergent via the detergent supply device 1060. The water mixed with the detergent may be supplied to the inside of the tub 1020. The detergent may include a conditioner for dryer, a deodorant, a sterilizer, or an air freshener, as well as a washing detergent. The detergent supply device 1060 may be connected to the tub 1020 through a connecting tube 1061.

The washing machine 1010 may include a drain device 1070. The drain device 1070 may discharge water accommodated in the tub 1020 to outside. The drain device 1070 may include a drain pump 1073 for discharging water accommodated in the tub 1020 to outside of the washing machine housing 1011, a connecting hose 1071 connecting the drain pump 1073 to the tub 1020 such that water stored in the tub 1020 flows to the drain pump 1073, and a drain hose 1074 for guiding water pumped by the drain pump 1073 to the outside of the washing machine housing 1011. The drain device 1070 may include a drain valve 1072 provided in the connecting hose 1071 to open or close the connecting hose 1071.

The washing machine 1010 may provide a user interface 1015 for interactions with a user.

The washing machine 1010 may include at least one user interface 1015. The user interface 1015 may include at least one input interface 1016 and/or at least one output interface 1017.

The at least one input interface 1016 may convert sensory information received from a user into an electrical signal.

The at least one input interface 1016 may include a power button, an operation button, a course selection dial (or a course selection button), and a washing/rinsing/dehydrating setting button. The at least one input interface 1016 may include, for example, a tact switch, a push switch, a slide switch, a toggle switch, a micro switch, a touch switch, a touch pad, a touch screen, a jog dial, and/or a microphone, etc.

The at least one output interface 1017 may generate sensory information and transfer various data related to an operation of the washing machine 1010 to a user.

For example, the at least one output interface 1017 may transfer information related to a washing course and an operation time of the washing machine 1010 or a washing setting/rinsing setting/dehydrating setting to a user. Information related to an operation of the washing machine 10 may be output through a screen, an indicator, a voice, etc. The at least one output interface 1017 may include, for example, a Liquid Crystal Display (LCD) panel, a Light Emitting Diode (LED) panel, a speaker, etc.

The water treatment apparatuses 1, 2, 3, 4, 5, 6, 7, 8, and 9 according to various embodiments may remove ions from water supplied to the washing machine 1010. FIGS. 15 and 16 show a case in which the water treatment apparatus 1 shown in FIG. 1 is provided for the washing machine 1010. However, the water treatment apparatuses 2, 3, 4, 5, 6, 7, 8, and 9 shown in FIGS. 7 to 14 may be provided for the washing machine 1010.

For example, the water treatment apparatus 1 may be positioned outside the washing machine 1010, as shown in FIG. 15. The water treatment apparatus 1 may be positioned outside the washing machine 1010 to remove ions from water that is supplied to the washing machine 1010. The water treatment apparatus 1 may be provided on a flow path that connects an external water supply source to the washing machine 1010.

For example, the water treatment apparatus 1 may be positioned inside the washing machine 1010, as shown in FIG. 16. The water treatment apparatus 1 may be connected to the water supply tube 1051. The water treatment apparatus 1 may be configured to remove ions from water passing through the water supply tube 1051. A position of the water treatment apparatus 1 is not limited to the water supply tube 1051, and the water treatment apparatus 1 may be provided at various positions which water to be supplied to the washing machine 1010 passes through.

The water treatment apparatus 1 according to various embodiments may be positioned outside and/or inside the washing machine 1010.

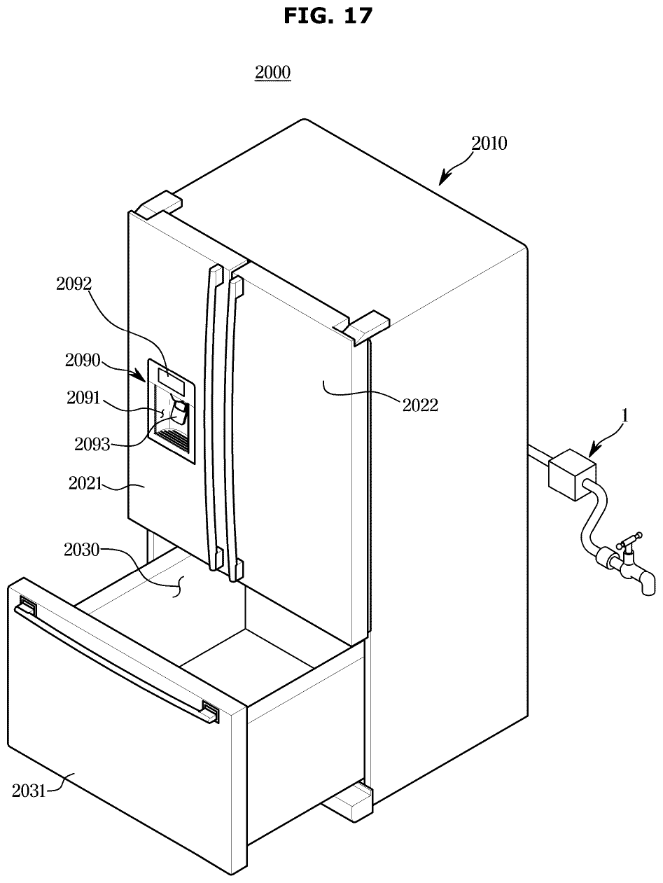

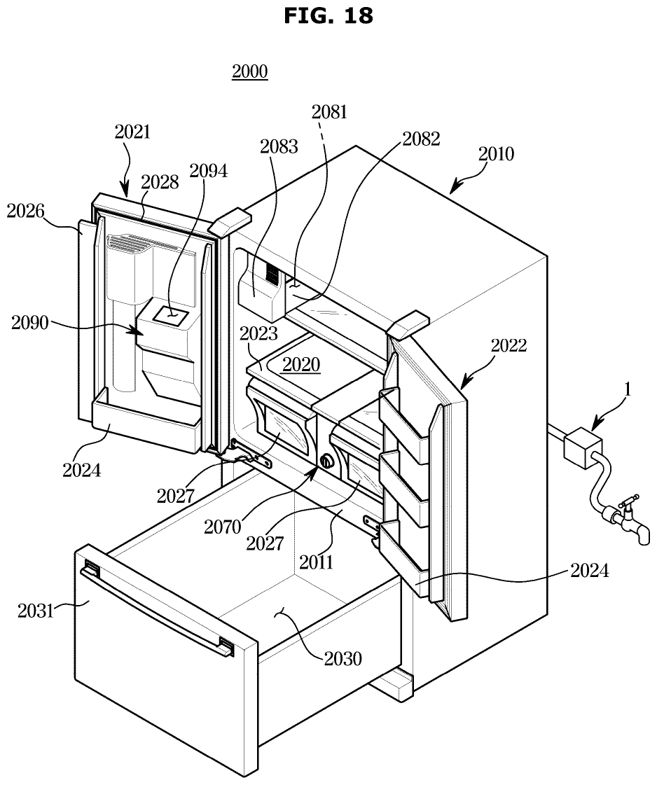

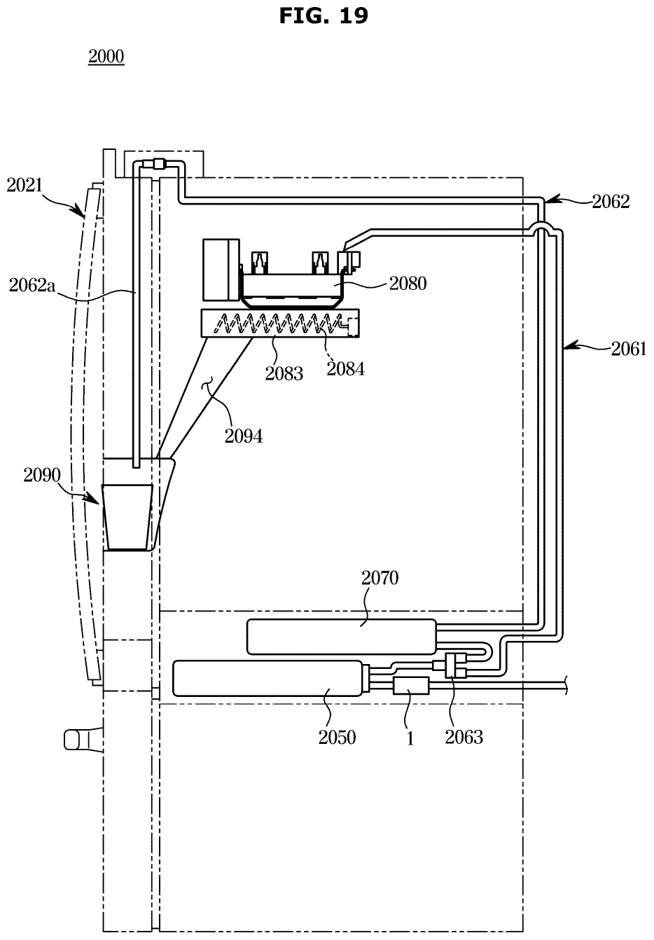

FIG. 17 shows a refrigerator to which a water treatment apparatus according to one or more embodiments of the disclosure is connected. FIG. 18 shows a refrigerator to which a water treatment apparatus according to one or more embodiments of the disclosure is connected, while a door of the refrigerator opens. FIG. 19 shows a cross section of a refrigerator to which a water treatment apparatus according to one or more embodiments of the disclosure is applied.

A refrigerator 2000 to which the water treatment apparatus 1 according to an embodiment of the disclosure is connected and/or applied will be described with reference to FIGS. 17 to 19.

The refrigerator 2000 according to an embodiment may include a main body 2010.

The main body 2010 may include an inner case, an outer case positioned outside the inner case, and an insulation provided between the inner case and the outer case.

The inner case may include at least one of a case, a plate, a panel, or a liner, which forms a storage room 2020 or 2030. The inner case may be formed as one body, or may be formed by assembling a plurality of plates together. The outer case may form an appearance of the main body 2010, and may be coupled to an outer side of the inner case to position the insulation between the inner case and the outer case.

The insulation may insulate inside of the storage room 2020 or 2030 from outside of the storage room 2020 or 2030 such that an internal temperature of the storage room 2020 or 2030 is maintained at a preset optimal temperature without being influenced by an external environment of the storage room 2020 or 2030. According to an embodiment of the disclosure, the insulation may include a foaming insulation. The foaming insulation may be molded by injecting urethane foam as a mixture of polyurethane and a foaming agent between the inner case and the outer case and foaming the urethane foam.

According to an embodiment of the disclosure, the insulation may further include a vacuum insulation, in addition to a foaming insulation, or the insulation may be configured only with a vacuum insulation, instead of a foaming insulation. The vacuum insulation may include a core material, and a cladding material accommodating the core material therein and sealing inside with vacuum or pressure close to vacuum. However, the insulation is not limited to a foaming insulation or a vacuum insulation mentioned above, and may include various materials capable of being used for insulation.

The storage room 2020 or 2030 may include a space defined by the inner case. The storage room 2020 or 2030 may further include an inner case that defines a space corresponding to the storage room 2020 or 2030. Various goods, such as food, medicine, cosmetics, etc., may be stored in the storage room 2020 or 2030, and the storage room 2020 or 2030 may open in at least one side to allow a user to put/take the goods in/out.

The refrigerator 2000 may include one or more storage rooms 2020 and 2030. In the case in which two or more storage rooms 2020 and 2030 are formed in the refrigerator 2000, the storage rooms 2020 and 2030 may have different purposes of use and may be maintained at different temperatures. To this end, the storage rooms 2020 and 2030 may be partitioned from each other by a partition wall 11 including an insulation.

The storage rooms 2020 and 2030 may be maintained within optimal temperature ranges according to the purposes of use, and may include a refrigerating room, a freezing room, or a temperature conversion room that are divided according to the purposes of use and/or the temperature ranges. The refrigerating room may be maintained at an appropriate temperature for keeping goods refrigerated and the freezing room may be maintained at an appropriate temperature for keeping goods frozen. The refrigerating may mean cooling goods without freezing the goods, and for example, the refrigerating room may be maintained within a range of 0° C. to 7° C. above zero. The freezing may mean freezing goods or cooling goods to keep the goods frozen, and for example, the freezing room may be maintained within a range of 1° C. to 20° C. below zero. The temperature conversion room may be used as any one of a refrigerating room or a freezing room according to a user's selection or regardless of a user's selection.

The storage rooms 2020 and 2030 may also be called various other terms, such as vegetable room, freshness room, cooling room, and ice-making room, in addition to refrigerating room, freezing room, and temperature conversion room, and the terms, such as refrigerating room, freezing room, temperature conversion room, etc., as used below need to be understood to represent the storage rooms 2020 and 2030 having the corresponding purposes of use and the corresponding temperature ranges.

Inside the storage room 2020 or 2030, a shelf 2023 on which food is put and at least one storage box 2027 for keeping food may be provided.

According to an embodiment, the refrigerator 2000 may include one or more doors 2011, 2022, and 2031 configured to open or close the open sides of the storage rooms 2020 and 2030. The doors 2021, 2022, and 2031 may respectively open or close the one or more storage rooms 2020 and 2030, or any one of the doors 2021, 2022, and 2031 may open or close the plurality of storage rooms 2020 and 2030. The doors 2021, 2022, and 2031 may be rotatably or slidingly mounted on a front side of the main body 1010.

While the doors 2011, 2022, and 2031 are in a closed state, the doors 2021, 2022, and 2031 may close the storage rooms 2020 and 2030. The doors 2021, 2022, and 2031 may include, like the main body 2010, an insulation to insulate the storage rooms 2020 and 2030 while the doors 2011, 2022, and 2031 are in the closed state.

According to an embodiment, the door 2021, 2022, or 2031 may include a door outer plate forming a front side of the door 2021, 2022, or 2031, a door inner plate forming a rear side of the door 2021, 2022, or 2031 and facing the storage room 2020 or 2030, an upper cap, a lower cap, and a door insulation surrounded by the door outer plate, the door inner plate, the upper cap, and the lower cap.

At edges of the door inner plate, a gasket 2028 may be provided to seal the storage room 2020 or 2030 by being pressed against the front side of the main body 2010 while the door 2021, 2022, or 2031 is closed. The door inner plate may include a dyke 2025 protruding backward to install a door basket 2024 for storing goods.

According to an embodiment, the refrigerator 2000 may include, in the case in which one storage room 2020 is opened or closed by two doors 2021 and 2022, a rotating bar 2026 that keeps cool air of the storage room 2020 by sealing between the two doors 2021 and 2022.

According to an embodiment, the door 2021, 2022, or 2031 may include a door body and a front panel detachably coupled to a front side of the door body and forming a front side of the door 2021, 2022, or 2031. The door body may include a door outer plate forming a front side of the door body, a door inner plate forming a rear side of the door body and facing a storage room, an upper cap, a lower cap, and a door insulation surrounded by the door outer plate, the door inner plate, the upper cap, and the lower cap.

The refrigerator 2000 may be classified into a French Door Type, a Side-by-Side Type, a Bottom Mounted Freezer (BMF), a Top Mounted Freezer (TMF), or a one-door refrigerator, according to arrangements of the doors 2021, 2022, and 2031 and the storage rooms 2020 and 2030.

According to an embodiment, the refrigerator 2000 may include a cool air supply device configured to supply cool air to the storage rooms 2020 and 2030.

The cool air supply device may include a machine, a mechanism, an electronic device, and/or a combination thereof, capable of generating cool air and guiding the cool air to cool the storage rooms 2020 and 2030.

According to an embodiment, the cool air supply device may generate cool air through a cooling cycle including compression, condensation, expansion, and evaporation processes of refrigerants. To this end, the cool air supply device may include a cooling cycle device having a compressor, a condenser, an expander, and an evaporator to drive the cooling cycle. According to an embodiment of the disclosure, the cool air supply device may include a semiconductor such as a thermoelectric element. The thermoelectric element may cool the storage rooms 2020 and 2030 by heating and cooling actions through the Peltier effect.

According to an embodiment, the refrigerator 2000 may include a machine room where at least some components belonging to the cool air supply device are installed.

The machine room may be partitioned and insulated from the storage rooms 2020 and 2030 to prevent heat generated from the components installed in the machine room from being transferred to the storage rooms 2020 and 2030. To dissipate heat from the components installed inside the machine room, the machine room may communicate with outside of the main body 2010.

According to an embodiment, the refrigerator 2000 may include a dispenser 2090 installed in any door 2021 to provide water and/or ice. The dispenser 2090 may be installed in the door 2021 to allow a user to access the dispenser without opening the door 2021.

The dispenser 2090 may include a water intake space 2091 that allows a user to place a container therein to receive water or ice, and an operation lever 2093 that enables a user to operate the dispenser 2090 to discharge water or ice.

According to an embodiment, the refrigerator 2000 may include an ice maker 2080 for forming ice. The ice maker 2080 may include an ice making tray that stores water, an ice transfer device for separating ice from the ice making tray, and an ice bucket 2083 that stores ice formed in the ice making tray.

The ice maker 2080 may be positioned in an ice making room 2081 provided in an upper corner of any storage room 2020. The ice making room 2081 may be partitioned from the storage room 2020 by an ice making room wall 2082. An auger 2084 may be provided in the ice making room 2081 to transport ice stored in the ice bucket 2083 to a chute 2094.

According to an embodiment, the refrigerator 2000 may include a water tank 2070 that stores water. The water tank 2070 may be connected to an external water supply source. The water tank 2070 may store water purified by a water purifying filter 2050. On a water supply line that connects the external water supply source to the water tank 207, a valve 2063 may be provided.

According to an embodiment, the refrigerator 2000 may include an ice-making water supply flow path for supplying water to the ice maker 2080, and a dispenser water supply flow path 2062 for supplying water to the dispenser 2090.

According to an embodiment, the refrigerator 2000 may include a controller for controlling the refrigerator 2000.

The controller may process a user input received by a user interface 2092, and control operations of the user interface 2092. The user interface 2092 may be provided by using an input interface and an output interface. The controller may receive a user input from the user interface 92. Also, the controller may transfer a display control signal and image data for displaying an image on the user interface 92 to the user interface 92, in response to a user input.

The input interface may include a key, a touch screen, a microphone, etc. The input interface may receive a user input and transfer the user input to a processor.

The output interface may include a display, a speaker, etc. The output interface may output various notifications, messages, information, etc. generated by the processor.

The water treatment apparatuses 1, 2, 3, 4, 5, 6, 7, 8, and 9 according to various embodiments may remove ions from water that is supplied to the refrigerator 2000. FIGS. 17 to 19 show a case in which the water treatment apparatus 1 shown in FIG. 1 is provided for the refrigerator 2000. However, the water treatment apparatuses 2, 3, 4, 5, 6, 7, 8, and 9 shown in FIGS. 7 to 14 may be provided from the refrigerator 2000.

The water treatment apparatus 1 according to various embodiments may be positioned outside and/or inside the refrigerator 2000.

For example, the water treatment apparatus 1 may be positioned outside the refrigerator 2000, as shown in FIGS. 17 and 18. The water treatment apparatus 1 may be positioned outside the refrigerator 2000 to remove ions from water that is supplied to the refrigerator 2000. The water treatment apparatus 1 may be provided on a flow path that connects an external water supply source to the refrigerator 2000.

For example, the water treatment apparatus 1 may be positioned inside the refrigerator 2000, as shown in FIG. 19. The water treatment apparatus 1 may be connected to a water supply line. The water treatment apparatus 1 may remove ions from water passing through the water supply line. A position of the water treatment apparatus 1 is not limited to the water supply line, and the water treatment apparatus 1 may be provided at various locations through which water to be supplied to the refrigerator 2000 passes.

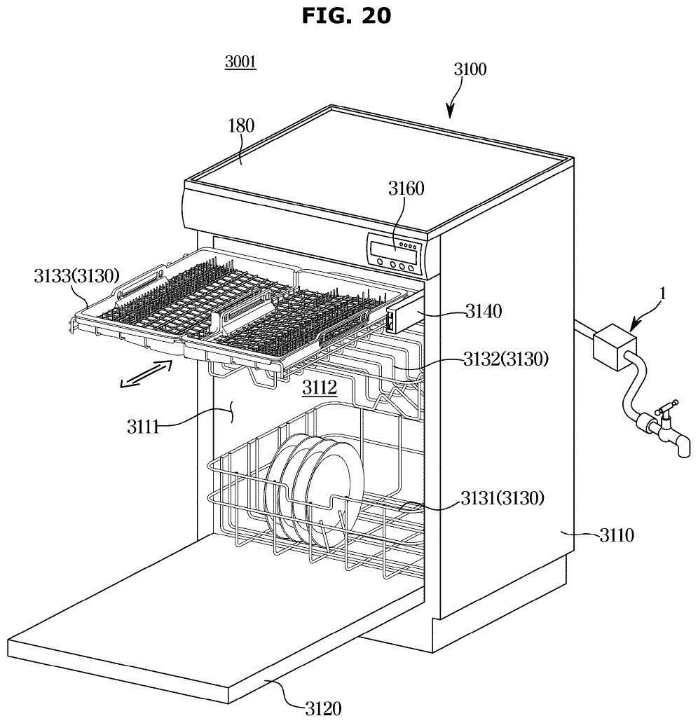

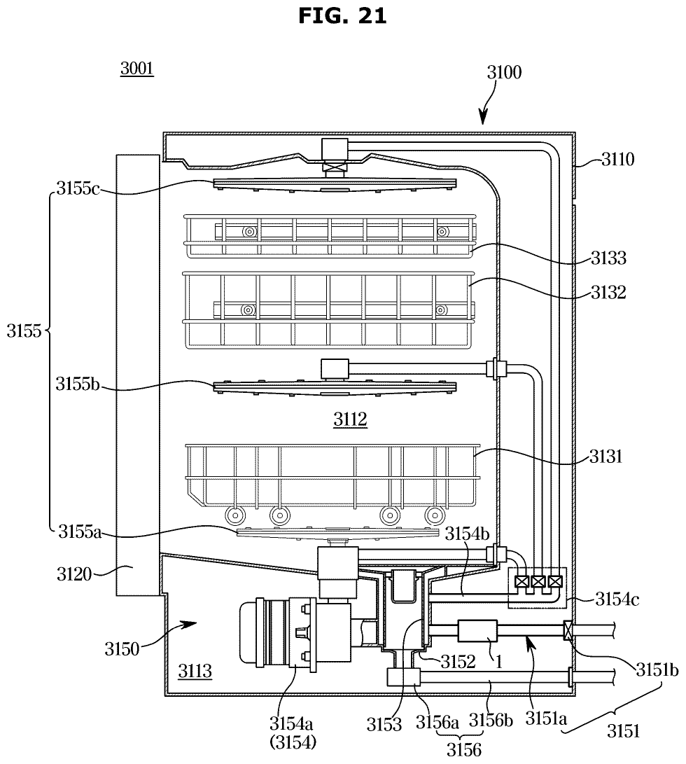

FIG. 20 shows a dishwasher to which a water treatment apparatus according to one or more embodiments of the disclosure is connected. FIG. 21 shows a cross section of a dishwasher to which a water treatment apparatus according to one or more embodiments of the disclosure is applied.

A dishwasher 3100 to which the water treatment apparatus 1 according to an embodiment of the disclosure is connected and/or applied will be described with reference to FIGS. 20 and 21.

The dishwasher 3100 may include a main body 3110, a door 3120, a storage portion 3130, a sliding member 3140, a washing assembly 3150, and a user interface 3160.

The main body 3100 may form an appearance of the dishwasher 3100. In one side of the main body 3110, an opening 3111 may be formed, and inside the main body 3110, a washing tank 3112 that is opened or closed by a door 3120, and a machine room 3113 spatially partitioned from the washing tank 3113 may be provided.

The door 3120 may be rotatable with respect to the main body 3110 to open or close the opening 3111 of the main body 3110. The door 3120 may be hinge-coupled to a lower portion of the main body 3110. In an outer side of the door 3120, a handle or a groove for a handle may be formed to allow a user to manually open the door 3120.

The storage portion 3130 may include first and second baskets 3133 and 3132 and a cutlery 3133 that are spaced from each other inside the washing tank 3112, slidable in a front-rear direction, have holes with various sizes, and store dishes, etc. thereon.

Here, the first basket 3131 may store various dishes, such as bowls, plates, and cooking tools, which are targets to be washed, the second basket 3132 may store cups, etc., and the cutlery 3133 may store forks, table knives, spoons, chopsticks, cooking knives, ladles, etc.

The sliding member 3140 may be provided inside the washing tank 3112 and guide and slide movements of the first and second baskets 3131 and 3132 and the cutlery 3133.

The washing assembly 3150 may be provided in the machine room 3113 and the washing tank 3112, and include a water supply portion 3151, a sump 3152, a heater 3153, a circulation portion 3154, a nozzle portion 3155, and a drain portion 3156 to perform washing, rinsing, and drying operations.

The water supply device 3151 may include a water supply tube 3151a positioned between an external water supply source and the sump 3152 and guiding water received from outside to the sump 3152, and a water supply valve 3151b for blocking inflow of water from the outside.

The sump 3152 may store water received through the water supply tube 3151a. A detergent may be dissolved in the water to become washing water, and the washing water may circulate through the wash tank 3112, the sump 3152, the circulation portion 3154, and the nozzle portion 3155.

The heater 3153 may be positioned around the sump 3152 to heat washing water in the sump 3152.

Also, the sump 3152 may be further provided with a temperature detector (not shown) for detecting a temperature of water.

The circulation portion 3154 may be provided between the sump 3152 and the nozzle portion 3155, pump washing water in the sump 3152 and supply the washing water to the nozzle portion 3155 through the circulation tube 3154b.

The circulation portion 3154 may include a circulation pump 3154a that pumps washing water in the sump 3152, a plurality of circulation tubes 3154b that guide the pumped washing water to the nozzle portion 3155, and a valve 3154c that is provided in each of the circulation tubes 3154b and adjusts circulation of the pumped washing water.

The nozzle portion 3155 may spray washing water supplied through the circulation portion 3154 toward various dishes stored in the first and second baskets 3131 and 3132 and the cutlery 3133.

The nozzle portion 3155 may include a first nozzle 3155a provided below the first basket 3131, a second nozzle 3155b provided between the first basket 3131 and the second basket 3132, and a third nozzle 3155c provided above the cutlery 3133. The first, second, and third nozzles 3155a, 3155b, and 3155c may be rotated by a rotor.

The drain portion 3156 may discharge washing water in the sump 3152 to the outside.

The drain portion 3156 may include a drain pump 3156a that pumps washing water in the sump 3152, and a drain tub 3156b that guides the pumped washing water to the outside. Also, the drain device 3156 may further include a drain valve (not shown) that adjusts discharge of washing water in the sump 3152 to the outside.

The user interface 3160 may be provided in the main body 3110 and control and display operation information of the dishwasher 3100.

The user interface 3160 may receive operation information, such as various washing courses (for example, a standard course, a manual course, etc.) and additional rinsing, according to a user's command, display information about an operation in progress, and display error information upon occurrence of an error.

Here, the washing course may include a washing operation that sprays washing water onto dishes to wash the dishes, a rinsing operation that sprays rinsing water onto the dishes to rinse the dishes, and a drying operation that dries the dishes completely rinsed.

The water treatment apparatuses 1, 2, 3, 4, 5, 6, 7, 8, and 9 according to various embodiments may remove ions from water that is supplied to the dishwasher 3100. FIGS. 20 and 21 show a case in which the water treatment apparatus 1 shown in FIG. 1 is provided for the dishwasher 3100. However, the water treatment apparatuses 2, 3, 4, 5, 6, 7, 8, and 9 shown in FIGS. 7 to 14 may be provided for the dishwasher 3100.

The water treatment apparatus 1 according to various embodiments may be positioned outside and/or inside the dishwasher 3100.

For example, the water treatment apparatus 1 may be positioned outside the dishwasher 3100, as shown in FIG. 20. The water treatment apparatus 1 may be positioned outside the dishwasher 3100 to remove ions from water that is supplied to the dishwasher 3100. The water treatment apparatus 1 may be provided on a flow path that connects an external water supply source to the dishwasher 3100.

For example, the water treatment apparatus 1 may be positioned inside the dishwasher 3100, as shown in FIG. 21. The water treatment apparatus 1 may be connected to the water supply tube 3151a. The water treatment apparatus 1 may be configured to remove ions from water passing through the water supply tube 3152a. However, a position of the water treatment apparatus 1 is not limited to the water supply tube 3151a, and the water treatment apparatus 1 may be provided at various positions through which water to be supplied to the dishwasher 3100 passes.

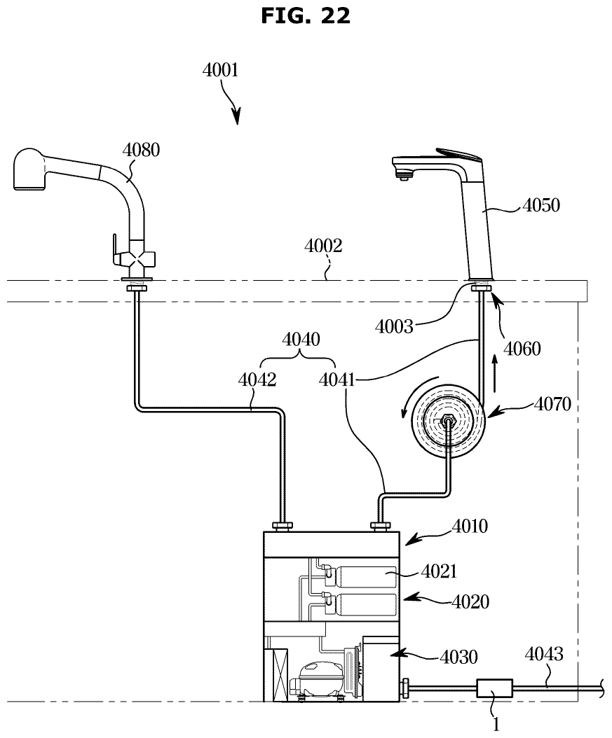

FIG. 22 shows a water purifier to which a water treatment apparatus according to one or more embodiments of the disclosure is applied.

A water purifier 4000 according to an embodiment of the disclosure will be described with reference to FIG. 22. The water purifier 4000 shown in FIG. 22 may include one of the water treatment apparatuses 1, 2, 3, 4, 5, 6, 7, 8, and 9 shown in FIGS. 1 to 14. For example, the water purifier 4000 shown in FIG. 22 may include the water treatment apparatus 1 shown in FIG. 1.

Referring to FIG. 22, the water purifier 4001 may include a filtering body 4010, and a dispenser 4050 connected to the filtering body 4010 to discharge a liquid from the filtering body 4010. The filtering body 4010 may be positioned in a lower portion of a kitchen worktop 4002, and the dispenser 4050 may be positioned on the kitchen worktop 4002. The kitchen worktop 4002 may include a kitchen sink. The kitchen sink may include a sink and a kitchen countertop.

The dispenser 4050 may be rotatable on the kitchen worktop 4002. For example, the dispenser 4050 may be rotatably installed on the kitchen sink. The dispenser 4050 may be connected to the filtering body 4010 through a connection pipe 4040.

The filtering body 4010 may be positioned inside the kitchen worktop 4002. The filtering body 4010 may include a filter unit 4020 including at least one filter 4021, and a heat exchange unit 4030 for cooling or heating a liquid purified by the filter unit 4020. The heat exchange unit 4030 may include a cooler and a heater.

The filtering body 4010 may receive raw water such as tap water through an external pipe 4043.

The connection pipe 4040 of the filtering body 4010 may include a first pipe 4041 that connects the filtering body 4010 to the dispenser 4050, and a second pipe 4042 that connects the filtering body 4010 to a faucet 4080 installed on the kitchen worktop 4002.

An installation member 4003 for installing the dispenser 4050 on the kitchen worktop 4002 may be provided in the kitchen worktop 4002. The installation member 4003 may be formed by opening at least a part of the kitchen worktop 4002. The dispenser 4050 may be connected to the first pipe 4041 through the installation member 4003 of the kitchen worktop 4002.

The dispenser 4050 may be rotatably installed in the installation member 4003. The water purifier 4001 may include a rotation member 4060 for rotatably installing the dispenser 4050 in the installation member 4003. The rotation member 4060 may be coupled to the kitchen worktop 4002.

The water purifier 4001 may include a pipe fixing member 4070 for fixing the pipes 4041 and 4042. The pipe fixing member 4070 may be positioned inside the kitchen worktop 4002. The pipe fixing member 4070 may be positioned between the filtering body 4010 and the dispenser 4050. The pipe fixing member 4070 may be fixed to any one of the filtering body 4010 or the kitchen worktop 4002. A part of the pipes 4041 and 4042 may be wound around the pipe fixing member 4070, and lengths of the pipes 4041 and 4042 may extend or be shortened as a part of the pipes 4041 and 4042 is released from or wound around the pipe fixing member 4070.

The water purifier 4001 according to an embodiment may include the water treatment apparatus 1. The water treatment apparatus 1 may be connected to the external pipe 4043. The water treatment apparatus 1 may be configured to remove ions from water passing through the external pipe 4043. A position of the water treatment apparatus 1 is not limited to the external pipe 4043, and the water treatment apparatus 1 may be provided at various positions through which water to be supplied to the water purifier 4000 passes.

A water treatment apparatus according to an embodiment may include a first electrode including a first current collector and a first porous electrode, a second electrode including a second current collector and a second porous electrode, a deionization channel formed between the first electrode and the second electrode, and a flow changer provided in the deionization channel and configured to change a flow of a fluid passing through the deionization channel. At least one of the first current collector or the second current collector may include a heating element configured to generate heat based on application of a voltage.

The flow changer may be positioned at a center area of the deionization channel in such a way as to be spaced from the first electrode and the second electrode.

The flow changer may include a first guide formed to approach closer to the first electrode in a direction in which the fluid passing through the deionization channel flows, and a second guide formed to approach closer to the second electrode in the direction in which the fluid passing through the deionization channel flows.

The flow changer may include a first change part positioned between the first electrode and the second electrode in the deionization channel, a second change part positioned between the first change part and the first electrode in the deionization channel, and a third change part positioned between the first change part and the second electrode in the deionization channel.

The flow changer may include a first change part being adjacent to the first electrode and a second change part being adjacent to the second electrode. The first change part and the second change part may be spaced from each other to allow a fluid to pass between the first change part and the second change part.

The flow changer may be configured to mix, among fluids passing through the deionization channel, a fluid flowing through an area of the deionization channel being adjacent to the first electrode with a fluid flowing through an area of the deionization channel being spaced from the first electrode, or mix a fluid flowing through an area of the deionization channel being adjacent to the second electrode with a fluid passing through an area of the deionization channel spaced from the second electrode.

The flow change may be configured to change a linear flow of the fluid passing through the deionization channel into a turbulent flow.

The heating element may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

Electrical resistivity of the heating element may range from 10⁻² Ωcm to 10⁻⁴ Ωcm.

At least one of the first porous electrode or the second porous electrode may include a carbon-based active material including at least one selected from among activated carbon, graphene, carbon nanotubes, carbon fibers, or carbon aerogel.

At least one of the first current collector or the second current collector may include a first part including the heating element and a second part including a material that is different from the first part.

The second part may include at least one metal or alloy selected from among aluminum, nickel, copper, titanium, iron, stainless steel, or graphite.

The first part and the second part may be arranged in a direction that is perpendicular to a direction in which the fluid passes through the deionization channel.

The water treatment apparatus may further include a partition wall partitioning the deionization channel into a first channel corresponding to the first part and a second channel corresponding to the second part.

A water treatment apparatus according to an embodiment may include a first ion removing module including a first electrode, a second electrode, and a first deionization channel formed between the first electrode and the second electrode, and a second ion removing module including a third electrode, a fourth electrode, and a second deionization channel formed between the third electrode and the fourth electrode. At least one of the first electrode or the second electrode may include a heating element configured to generate heat based on application of a voltage. The third electrode and the fourth electrode may include a material that is different from a material of the first electrode and the second electrode.

The heating element may include at least one metal or alloy selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

At least one of the third electrode or the fourth electrode may include at least one metal or alloy selected from among aluminum, nickel, copper, titanium, iron, stainless steel, or graphite.

The water treatment apparatus may include an apparatus inlet through which a fluid flows into the water treatment apparatus, a first module inlet extending from the apparatus inlet to the first ion removing module, a second module inlet extending from the apparatus inlet to the second ion removing module, and a path adjuster configured to guide a fluid flowed into the water treatment apparatus through the apparatus inlet to at least one of the first module inlet or the second module inlet.

The water treatment apparatus may further include a flow path adjustor provided in at least one of the first deionization channel or the second deionization channel and configured to change a size of the first deionization channel or the second deionization channel.

A method of manufacturing a water treatment apparatus according to an embodiment, the water treatment apparatus including a first electrode including a first current collector and a first porous electrode, a second electrode including a second current collector and a second porous electrode, and a deionization channel formed between the first electrode and the second electrode, may include operation of applying a carbon-based active material onto the second current collector or the first current collector including a heating element to form the first electrode or the second electrode. The heating element may include at least one metal selected from among Ni, Cr, Mo, W, Pt, Ti, Ta, NiCr, FeCr, FeNiCr, FeCoNi, FeCrAl, TaAl, SnO, HfB2, RuCr, IrCr, or CoCr.

According to a concept of the disclosure, because the first current collector and/or the second current collector includes a material capable of generating heat, the water treatment apparatus may provide hot water.

According to a concept of the disclosure, because the first current collector and/or the second current collector includes a material capable of generating heat, the water treatment apparatus may improve ion removal efficiency.

Effects that may be achieved by the disclosure are not limited to the above-mentioned effects, and other effects not mentioned will be clearly understood by one of ordinary skill in the technical field to which the disclosure belongs from the following descriptions.

So far, specific embodiments have been shown and described, however, the disclosure is not limited to these embodiments. It should be interpreted that various modifications may be made by one of ordinary skill in the technical art to which the disclosure belongs, without deviating from the gist of the technical concept of the disclosure, which is defined in the following claims.

What is claimed is:

1. A water treatment apparatus comprising:
a first electrode including a first current collecting layer and a first porous electrode;
a second electrode including a second current collecting layer and a second porous electrode;
a deionization channel formed between the first electrode and the second electrode; and
a flow changer provided as an internal structure within the deionization channel and configured to change a flow of fluid passing through the deionization channel,
wherein at least one of the first current collecting layer or the second current collecting layer comprises a heating element configured to generate heat based on application of a voltage.

2. The water treatment apparatus of claim 1, wherein
the flow changer is positioned at a center area of the deionization channel and is spaced from the first electrode and the second electrode.

3. The water treatment apparatus of claim 1, wherein
the flow changer comprises:
a first guide surface that extends closer to the first electrode in a direction in which the fluid passing through the deionization channel flows; and
a second guide surface that extends closer to the second electrode in the direction in which the fluid passing through the deionization channel flows.

4. The water treatment apparatus of claim 1, wherein
the flow changer comprises:
a first change part between the first electrode and the second electrode in the deionization channel;
a second change part between the first change part and the first electrode in the deionization channel; and
a third change part between the first change part and the second electrode in the deionization channel.

5. The water treatment apparatus of claim 1, wherein
the flow changer comprises a first change part being positioned closer to the first electrode than to the second electrode, and a second change part being positioned closer to the second electrode than to the first electrode, and
the first change part and the second change part are spaced from each other to allow the fluid to pass between the first change part and the second change part.

6. The water treatment apparatus of claim 1, wherein
the flow changer is configured to mix a fluid flowing through an area of the deionization channel being positioned closer to the first electrode than to the second electrode, with a fluid flowing through an area of the deionization channel being spaced from the first electrode, or mix a fluid flowing through an area of the deionization channel being positioned closer to the second electrode than to the first electrode, with a fluid passing through an area of the deionization channel spaced from the second electrode.

7. The water treatment apparatus of claim 1, wherein
the flow changer is configured to change the flow of the fluid that linearly passes through the deionization channel into a turbulent flow.

8. The water treatment apparatus of claim 1, wherein
the heating element includes at least one metal or alloy selected from among nickel (Ni), chromium (Cr), molybdenum (Mo), tungsten (W), platinum (Pt), titanium (Ti), tantalum (Ta), nickel-chromium alloy (NiCr), iron-chromium alloy (FeCr), iron-nickel-chromium alloy (FeNiCr), iron-cobalt-nickel alloy (FeCoNi), iron-chromium-aluminum alloy (FeCrAl), tantalum-aluminum alloy (TaAl), stannous oxide (SnO), hafnium diboride (HfB2), ruthenium-chromium alloy (RuCr), iridium-chromium alloy (IrCr), or cobalt-chromium alloy (CoCr).

9. The water treatment apparatus of claim 1, wherein
electrical resistivity of the heating element ranges from 10⁻² Ωcm to 10⁻⁴ Ωcm.

10. The water treatment apparatus of claim 1, wherein
at least one of the first porous electrode or the second porous electrode comprises a carbon-based active material including at least one selected from among activated carbon, graphene, carbon nanotubes, carbon fibers, or carbon aerogel.

11. The water treatment apparatus of claim 1, wherein
at least one of the first current collecting layer or the second current collecting layer comprises a first part comprising the heating element and a second part comprising a material that is different from a material included in the first part.

12. The water treatment apparatus of claim 11, wherein
the second part comprises at least one metal or alloy selected from among aluminum, nickel, copper, titanium, iron, stainless steel, or graphite.

13. The water treatment apparatus of claim 11, wherein
the first part and the second part are arranged in a direction that is perpendicular to a direction in which the fluid passes through the deionization channel.

14. The water treatment apparatus of claim 13, further comprising
a partition wall partitioning the deionization channel into a first channel corresponding to the first part and a second channel corresponding to the second part.

15. The water treatment apparatus of claim 1, wherein the first electrode and the second electrode have opposite polarities, and the first porous electrode and the second porous electrode comprises a thermally conductive material.

16. The water treatment apparatus of claim 1, further comprising:
an anion exchange membrane configured to allow a passage of anions while blocking cations within the fluid; and
an cation exchange membrane configured to allow a passage of the cations while blocking the anions within the fluid.

17. The water treatment apparatus of claim 16, wherein an anion channel is provided between the first current collecting layer and the anion exchange membrane, and a cation channel is provided between the second current collecting layer and the cation exchange membrane, and
wherein the first porous electrode is provided in the anion channel between the first current collecting layer and the anion exchange membrane, and the second porous electrode is provided in the cation channel between the second current collecting layer and the cation exchange membrane.

18. A water treatment apparatus comprising:
a first ion removing module comprising a first electrode, a second electrode, and a first deionization channel provided between the first electrode and the second electrode; and
a second ion removing module comprising a third electrode, a fourth electrode, and a second deionization channel provided between the third electrode and the fourth electrode,
wherein at least one of the first electrode or the second electrode comprises a heating element configured to generate heat based on application of a voltage, and
the third electrode and the fourth electrode comprises a material that is different from a material of the first electrode and the second electrode.
